(19) United States
(12) Patent Application Publication
(10) Pub. No.: US 2023/0371761 A1
(43) Pub. Date: Nov. 23, 2023

(54) DEVICE AND METHOD FOR TREATING HUMAN WASTE

(71) Applicant: HARVEST MOON AB, Stockholm (SE)

(72) Inventors: Åsa KARLSSON, Stockholm (SE); Peter THUVANDER, Stockholm (SE); Karin HABERMANN, Hägersten (SE)

(21) Appl. No.: 18/247,125

(22) PCT Filed: Sep. 30, 2021
(86) PCT No.: PCT/SE2021/050964

§ 371 Date: Mar. 29, 2023

(30) Foreign Application Priority Data
Oct. 1, 2020 (SE) 2051147-3

(51) Int. Cl. A47K 11/02; C02F 1/04

(52) U.S. Cl. CPC A47K 11/02; C02F 1/048

(57) ABSTRACT

The present invention relates to a device (10) for treating human waste from a toilet (C), the device comprising a waste receptacle unit (A), a drying unit (B), a moisture recovery unit (42) and air circulation (52, 53). The invention also relates to a method for drying human waste from a toilet (C).

### TECHNICAL FIELD

The present invention relates to a method and device for treating human waste, the device comprising a waste receptacle unit and a drying unit for drying human waste held in the receptacle unit. The method comprises operating the drying unit so that moisture in the human waste in the waste receptacle unit is removed.

### BACKGROUND

The managing and treatment of human waste in the form of urine and feces is a technical field of increasing importance. In most developed countries, toilets consuming large quantities of water are used to flush human waste through a sewer system to treatment plants, where the waste is captured and the water purified before releasing the water into adjacent streams or lakes. This manner of handling human waste has significant drawbacks, among them the consumption of very large quantities of water and the difficulties in capturing waste substances so that the water released from the treatment plants is clean enough to avoid overfertilization of streams, lakes and land surrounding them. Although the methods for handling urine and feces are well-developed and reliable there is insufficient knowledge of how to handle additional substances such as drugs and other chemicals that are released from humans through their urine. As a result, substances such as antibiotics, hormones or narcotics may still be present in the water released from treatment plants and may pose a risk to organisms such as fish. If the water released from the treatment plants is able to penetrate lakes or reservoirs used as fresh water supply for cities there is also a risk that such substances may be present in drinking water.

In some parts of the world, the problem is instead that sanitary solutions such as toilets are unreliable or not present at all. This results in the need to handle and transport human waste without the aid of sewers and also poses a health risk both to persons responsible for such handling and to persons who live without access to satisfactory toilets.

There are some known prior art toilets that attempt to resolve these problems through providing toilets that require low amounts of water or that attempt to handle human waste without using water at all. However, there are no known solutions that provide a safe and convenient toilet that minimizes water consumption and odor and at the same time avoids human handling of the waste.

There is therefore a need for an improved toilet that solves these problems in a convenient, reliable and cost-effective way.

### SUMMARY

The object of the present invention is to eliminate or at least to minimize the problems discussed above. This is achieved by a device and method for handling human waste according to the appended independent claims, and also to software for performing the method.

The present invention comprises two main aspects that differ from each other in that a heating device is used to heat circulating air in a first aspect and to heat human waste in a second aspect. Apart from the medium to which heat from the heating device is applied, the two aspects are similar or identical so that features from one aspect may be combined with the other aspect as well. Furthermore, in a third aspect the invention encompasses placing the cooling device upstream of the waste receptacle in which human waste is held so that air that enters the device is cooled in order to remove moisture from the air before the air is supplied to the waste receptacle. In embodiments of the third aspect where air is used as a medium for heating the human waste similar to the first aspect, the heating device is arranged between the cooling device and the waste receptacle. However, in embodiments of the third aspect where heating is applied to the human waste in the waste receptacle similar to the second aspect the air is supplied from the cooling device to the waste receptacle without being heated.

Thus, the first aspect and the second aspect differ mainly in the use of the heating device whereas the third aspect differs from the first and second aspects mainly in the placement of the cooling device. However, all three aspects form part of the same inventive concept and achieves the main benefits and advantages of the invention as disclosed herein. It is to be noted that features from any of the aspects may freely be combined with embodiments of any of the other aspects.

Features and benefits of the first aspect will now be explained.

The device according to the present invention comprises a waste receptacle unit for receiving and holding human waste and a drying unit for drying the human waste, the drying unit comprising an inlet air conduit connected to the waste receptacle unit such that air is able to enter the waste receptacle unit via the inlet air conduit, and the drying unit also comprising an outlet air conduit connected to the waste receptacle unit such that air is able to exit the waste receptacle unit via the outlet air conduit. Further, the drying unit comprises a heating device for heating air, the heating device being operatively connected to the inlet air conduit such that air heated by the heating device is able to enter the inlet air conduit and also comprises a moisture recovery device for recovering moisture from air, the moisture recovery device being operatively connected to the outlet air conduit such that moisture can be recovered from air that has exited the waste receptacle unit through the outlet air conduit. Also, the drying unit comprises a connection for transporting air from the moisture recovery device to the heating device, such that air is circulated in the drying unit.

It is a particular advantage of the invention that air is circulated in the drying unit so that the same quantity of air is used repeatedly for drying the human waste. This is achieved through a loop where air is heated, transported through the waste receptacle unit such that the human waste is dried through the air absorbing moisture. Then, moisture is removed from the air before renewed heating of the air takes place. In this way, air is circulated in the drying unit until a moisture content of the human waste is sufficiently lowered. In some embodiments, a controlled volume of air may enter and/or exit the device during operation of the drying unit, as long a the air present inside the device is largely retained in order to achieve the efficiency benefits of circulation.

By drying the human waste, it is rendered significantly easier to handle and transport since the weight of the waste may be reduced by at least 40% and in some embodiment up to 90% or even higher. This also creates the opportunity of using the treated human waste as fertilizer due to the lower amounts of bacteria present after drying, so that nutrients present in the waste may be used without cumbersome further processing.

Suitably, the drying unit forms a closed air loop such that air passes the heating device, the waste receptacle unit, the moisture recovery device and the heating device again during operation of the drying unit without contact with ambient air. This is beneficial in minimizing energy consumption since a more efficient heating can be achieved when an inlet of ambient air is avoided so that the same air supply is heated and reheated. It is also an advantage since odors arising from substances such as volatile organic compounds, VOC, present in the human waste are prevented from exiting the drying unit.

Also, the waste receptacle unit may comprise a urine receptacle and a feces receptacle, and the waste receptacle unit may further comprise a separator for separating human waste into the urine receptacle and the feces receptacle. In this way, urine and feces may be treated separately in order to further increase efficiency of the drying process. Also, this allows for the urine and feces being separately handled, transported, and possibly used as fertilizer or in other ways to capture nutrients present in the waste. They can thus be used for different purposes and in separate locations which allows for an increased efficiency in recovering and using nutrients from the urine and feces.

Suitably, the inlet air conduit of the drying unit is connected to an air inlet of the urine receptacle and preferably also to an air inlet of the feces receptacle, such that air transported in the inlet air conduit is able to enter the urine receptacle and preferably also the feces receptacle. Also, the outlet air conduit of the drying unit is suitably connected to an air outlet of the urine receptacle and preferably an air outlet of the feces receptacle, such that air that exits the urine receptacle and preferably also air that exits the feces receptacle is able to enter the outlet air conduit. Thereby, air can be circulated in the urine receptacle and the feces receptacle separately so that the drying can be adjusted to suit the presence of different quantities of urine and feces. Also, it is possible to use the device for drying the urine while at the same time using another treatment for the feces or simply storing feces for subsequent removal from the device without drying it first.

The urine receptacle may also comprise urine collection unit for collecting at least one material from the urine. Thereby the dried urine may be captured in the urine collection unit and may then be removed from the device.

Also, the feces receptacle may comprise a feces container for holding dried feces. This also enables the collection of feces and subsequent removal of dried feces from the device.

Suitably, the drying unit further comprises a filter for capturing particles from the feces receptacle, said filter being arranged in connection with the feces receptacle or the outlet air conduit. Thereby, particles from the feces are prevented from circulating in the drying unit. This is especially advantageous in preventing contamination of the drying unit and preventing bacterial growth in the device so that cleaning and maintenance is facilitated.

Also, the device may comprise a heating element arranged in connection with the feces receptacle such that the heating element is able to transfer heat to feces held in the feces receptacle. Thereby, feces may be dried by heating provided by the heating element in order to further render the drying more efficient.

Suitably, at least one of the urine collection unit and the feces container is replaceable. Thereby, a urine collection unit and/or feces container may be removed and replaced when full in order to render handling of the dried urine and feces easier and more convenient.

Also, the drying unit may further comprise an air circulation device for circulating air in the drying unit. Thereby the drying is facilitated through providing a controlled air circulation.

Suitably, the moisture recovery device may be configured to remove moisture from the air through condensation. Thereby, moisture is removed in an efficient way.

Also, the heating device and the moisture recovery device may be a heat pump. Thereby, condensation and heating may be provided in an integrated device so that the drying is rendered efficient while at the same time being energy efficient.

Suitably, the drying unit may further comprise a capturing device for capturing particles and/or volatile organic compounds, VOC, from the air. The capturing device may preferably be arranged in the outlet air conduit. Thereby, particles and gas that have been released from the human waste may be captured to prevent them from circulating and contaminating the drying unit, and also to prevent odor from escaping the device so that unpleasant smells are avoided. The capturing device may comprise a filter that is arranged in the outlet air conduit such that the air passes through the filter. This is a particularly efficient way of achieving the capture of particles and gas.

Also, the device may comprise a receiving unit for receiving human waste, and the device may also comprise a cleaning device for cleaning the receiving unit. The cleaning device suitably comprises at least one nozzle for spraying a cleaning fluid into the receiving unit. Thereby, the receiving unit that may typically be a toilet bowl that is available to a user, can be cleaned as desired in order to remain clean and user friendly.

Suitably, the cleaning device may be operatively connected to the drying unit for receiving recovered moisture from the drying unit, and the cleaning fluid may be said recovered moisture. Thereby, the device may be operated, and the receiving unit cleaned without needing access to an external water supply. This is especially advantageous in locations or areas where access to water is limited.

Also, the cleaning device may comprise a steaming unit for heating the cleaning fluid to produce steam and the at least one nozzle may be configured for spraying steam into the receiving unit for cleaning. Thereby, steam may be used to disinfect the receiving unit so that bacterial growth is avoided.

The device may further comprise a control unit for operating the drying unit. Thereby, the drying may be controlled. Also, at least one sensor may be provided for determining a moisture content of the human waste in the waste receptacle unit, and that sensor may be operatively connected to the control unit. Thereby, drying may be performed as long as needed and may be interrupted as soon as the waste is considered dry enough. This is advantageous in providing an energy efficient drying that ensures that the human waste reaches a sufficient dryness while at the same time avoiding unnecessary operating of the drying unit after the moisture content of the human waste has already been sufficiently lowered.

The present invention also comprises a method for treating human waste, comprising providing a device comprising a drying unit and a waste receptacle unit for receiving and holding human waste, heating air by means of a heating device in the drying unit, supplying heated air to the waste receptacle unit for removing moisture from human waste held in the waste receptacle unit, and transporting air from the waste receptacle unit and recovering moisture from said air by means of a moisture recovery device in the drying unit to create dry air. Further, the method comprises repeating the steps of heating air, supplying the air to the waste receptacle unit and removing moisture from the air so that air is circulated in the drying unit.

The drying unit may form a closed air loop such that air is circulated through steps of the method without contact with ambient air. Also, the method may comprise separating waste in the waste receptacle unit such that urine is separated into a urine receptacle, and feces is separated into a feces receptacle, wherein the separation takes place before drying the human waste. Furthermore, the air supplied to the waste receptacle unit may be supplied to the urine receptacle and preferably also to the feces receptacle. Also, the method may comprise collecting at least one material from the urine in the urine receptacle. The method may also comprise filtering air transported from the feces receptacle such that particles from the feces are prevented from being circulated in the drying unit. The feces receptacle may also be heated by means of a heating element. The urine receptacle and/or feces receptacle may also be replaced. The method may comprise capturing particles and/or volatile organic compounds, VOC, from the air. Also, the method may comprise detecting a moisture content of the waste in the waste receptacle unit, and also comprise performing the heating, air supply to the waste receptacle unit and recovering moisture until said moisture content is below a predetermined moisture threshold. Also, the method may comprise cleaning a receiving unit for receiving human waste, said receiving unit being configured to receive waste from a human and transporting said waste to the waste receptacle unit, wherein further cleaning the receiving unit comprises spraying a cleaning fluid into the receiving unit. Suitably, recovered moisture from the drying unit may be used as cleaning fluid, preferably also being heated to generate steam before spraying it into the receiving unit.

Features of the second aspect will now be explained.

The invention according to the second aspect comprises a device for treating human waste, the device comprising a waste receptacle unit for receiving and holding human waste and a drying unit for drying the human waste. The drying unit comprises an inlet air conduit connected to the waste receptacle unit such that air is able to enter the waste receptacle unit via the inlet air conduit and an outlet air conduit connected to the waste receptacle unit such that air is able to exit the waste receptacle unit via the outlet air conduit. The drying unit also comprises a heating device for heating human waste in the waste receptacle unit and a moisture recovery device for recovering moisture from air, the moisture recovery device being operatively connected to the outlet air conduit such that moisture can be recovered from air that has exited the waste receptacle unit through the outlet air conduit. Furthermore, the drying unit comprises a connection for transporting air from the moisture recovery device to the inlet air conduit, such that air is circulated in the drying unit.

Also, the second aspect of the present invention comprises a method for treating human waste, the method comprising providing a device comprising a drying unit and a waste receptacle unit for receiving and holding human waste and heating human waste in the waste receptacle unit by means of a heating device. Also, the method comprises supplying air to the waste receptacle unit for removing moisture from the heated human waste, and transporting air from the waste receptacle unit and recovering moisture from said air by means of a moisture recovery device in the drying unit to create dry air. The method further comprises repeating the steps of supplying air to the waste receptacle unit and recovering transporting air from the waste receptacle unit and recovering moisture from the air such that air is circulated in the drying unit.

By heating the human waste, preferably a mixture of urine and feces or only urine, an efficient operation of the heating device is achieved. Apart from this additional benefit, the advantages described above with reference to the first aspect apply equally to the second aspect.

Features of the third aspect will now be explained.

The device according to the present invention comprises an air intake for passing incoming air into the device; an air outlet for passing outgoing air out from the device; a cooling device for cooling air, thereby recovering moisture from the air; a waste receptacle for holding human waste; a heating device configured to heat human waste comprised in the device; and an airflow device configured to generate an airflow in the device in a flow direction. The device is configured to convey air in the flow direction from the air intake to the cooling device, from the cooling device to the waste receptacle and from the waste receptacle to the air outlet.

The device thus enables cooling of air, and thereby drying of the air as the cooling results in recovery of moisture from the air, in combination with heating of the human waste comprised in the device. Suitably, the air that is passed through the waste receptacle thereby has an improved drying capacity and the efficiency and/or speed of removing moisture from the human waste is increased. The increased temperature of the human waste contributes to improving the efficiency and/or speed of removing moisture from the human waste. A further advantage of removing moisture from/drying human waste, it is rendered significantly easier to handle and transport since the weight of the waste may be reduced by at least 40% and in some embodiment up to 90% or even higher. This also creates the opportunity of using the treated human waste, which may be dry waste or partially dried waste in the form of a concentrate, as fertilizer due to the lower amounts of bacteria present after drying, so that nutrients present in the waste may be used without cumbersome further processing. For example, heating the waste above a certain temperature for a set amount of time, as known in the art, will result in the death of most pathogens.

The heating device may be configured to heat human waste comprised in the device via a medium. In some embodiments, the medium is air and the heating device is arranged downstream of the cooling device and upstream of the waste receptacle in the flow direction, such that the heating device heats the air cooled by the cooling device before the air passes through the waste receptacle. Thereby, the air is first dried by the cooling device, whereby moisture in the air is recovered contributing to the air obtaining an increased drying capacity. Thereafter the air is heated to a higher temperature before it passes through the waste receptacle, meaning that the air heats the waste comprised in the waste receptacle as it passes through the waste receptacle, contributing to an increased evaporation of moisture from the waste. Advantageously, moisture in the waste is thereby caused to evaporate more efficiently when the air passes through the waste receptacle, by the combination of the air being both dry and heated. Alternatively, the heating device is arranged in the waste receptacle for heating human waste and/or air comprised therein.

Optionally, the device may comprise a connection for transporting air from the air outlet to the air intake, such that air is circulated in the device, whereby the same quantity of air may be used repeatedly for drying the human waste. The device may in these embodiments form a closed air loop such that air passes the cooling device, the heating device, if this is arranged in the airflow, the waste receptacle and the cooling device again during operation of the device, without contact with ambient air. This is beneficial in minimizing energy consumption since a more efficient heating can be achieved when an inlet of ambient air is avoided. It is also an advantage since odors arising from substances such as volatile organic compounds, VOC, present in the human waste are prevented from exiting the device.

The cooling device may suitably be configured to remove moisture from the air through condensation. Thereby, moisture is removed in an efficient way.

The waste receptacle may comprise a urine receptacle and a feces receptacle, and further comprise a separator for separating human waste into the urine receptacle and the feces receptacle. Advantageously, in these embodiments, waste in the form of only urine or only feces, or a mix, may be exposed to the air for drying and collection of material from the waste.

In one or more embodiment, the device further comprises a capturing device for capturing particles and/or volatile organic compounds, VOC, from the air, said capturing device preferably being operatively connected to the air outlet. Thereby, particles and gas that have been released from the human waste may be captured to prevent them from circulating and contaminating the drying unit, and also to prevent odor from escaping the device so that unpleasant smells are avoided. The capturing device may comprise a filter that is arranged in, or operatively connected to, the air outlet air conduit such that the air passes through the filter. This is a particularly efficient way of achieving the capture of particles and gas.

The heating device and the cooling device, or moisture recovery device, may be two separate devices but in some embodiments they may instead be integrated into a single component. Such a single component may suitably be a heat pump where moisture is recovered through condensation but may alternatively be realized as a thermoelectric generator or another component that is able to realize both heating and moisture recovery. Thereby, condensation and heating may be provided in an integrated device so that the drying is rendered efficient while at the same time being energy efficient. In other embodiments, moisture could instead be removed by chemical binding, for instance using a salt such as potassium chloride or sodium chloride or using another suitable substance such as silica gel (silicone dioxide). Heating could in such embodiments be provided by a heating cartridge or by a heating element or similar that is able to heat an airflow.

The device may in some embodiments comprise one or more valve for selectively introducing ambient air into the device. By the use of one or more valve, or other suitable means for selectively closing off and opening the air intake and/or the air outlet, it can be selected whether to use a linear airflow through the device, or a circulating air flow within the device, or a combination.

In one or more embodiment, the device further comprises a vacuum chamber enclosing the waste receptacle, the cooling device and the heating device, and the device also comprises a vacuum pump for generating a vacuum in the vacuum chamber, the vacuum pump being operatively connected to the vacuum chamber. Suitably, by introducing a vacuum in the device, the pressure in the device and hence the boiling point of the liquid to be removed from the human waste is reduced whereby the moisture removal process becomes more energy efficient.

The device may further comprise a control unit for operating the device. Thereby, the removal of moisture from the human waste comprised in the device may be controlled. Suitably, controlling the removal of moisture, by a control unit or otherwise, enables optimization of the removal of moisture with regard to minimizing time or maximizing energy efficiency. Also, at least one sensor may be provided for determining a moisture content of the human waste in the waste receptacle unit, and that at least one sensor may be operatively connected to the control unit. Thereby, removal of moisture, or drying, may be performed as long as needed and may be interrupted as soon as the waste is considered dry enough. This is advantageous in providing an energy efficient drying that ensures that the human waste reaches a sufficient dryness while at the same time avoiding unnecessary operating of the device after the moisture content of the human waste has already been sufficiently lowered.

The method according to the present invention comprises providing a device comprising an air intake for passing incoming air into the device, an air outlet for passing outgoing air out from the device, and a waste receptacle for holding human waste, cooling air in the device by means of a cooling device, thereby recovering moisture from the air, and heating human waste comprised in the device by means of a heating device. The method further comprises conveying air by means of an airflow device in a flow direction from the air intake to the cooling device, from the cooling device to the waste receptacle and from the waste receptacle to the air outlet.

Heating human waste comprised in the device by means of the heating device may comprise heating the human waste via a medium. The medium may be air, and heating human waste comprised in the device by means of the heating device may be done downstream of the cooling of air in the device by means of the cooling device and upstream of the waste receptacle in the flow direction, such that the air cooled by the cooling device is heated before the air passes through the waste receptacle.

In some embodiments, which may be combined with one or both of the options for heating via a medium, the heating of human waste comprised in the device by means of the heating device comprises heating human waste or air in the waste receptacle.

In some embodiments the method further comprises circulating the air in the device by transporting the air via a connection from the air outlet to the air intake. The method may then further comprise conveying air in a closed air loop such that air passes the cooling device, the heating device, if this is arranged in the airflow, the waste receptacle and the cooling device again during operation of the drying unit without contact with ambient air.

The method may comprise removing moisture from the air through condensation by cooling air in the device by means of the cooling device.

In one or more embodiments, the method further comprises separating waste in the waste receptacle such that urine is separated into a urine receptacle and feces is separated into a feces receptacle before the steps of cooling air, heating human waste, and conveying air in the device. In these embodiments, it may be only urine or urine concentrate, only feces or feces concentrate, or a mix or concentrate comprising both urine and feces that is exposed to the air flowing in the device.

In one or more embodiment, the method further comprises capturing particles and/or volatile organic compounds, VOC, from the air downstream of the waste receptacle in the flow direction using a capturing device.

The method may further comprise selectively introducing ambient air into the device by means of a valve.

In some embodiments, the method may further comprise generating a vacuum in a vacuum chamber enclosing the waste receptacle by means of a vacuum pump operatively connected to the vacuum chamber.

The method may further comprise operating or controlling the device by means of a control unit. In one or more embodiment, the method further comprises detecting a moisture content of the waste in the waste receptacle, and also performing the steps of cooling air, heating human waste, and conveying air in the device until said moisture content is below a predetermined moisture threshold.

The advantages described above with reference to the device embodiments apply equally to the corresponding method embodiments and the software for performing the method.

Many additional benefits and advantages of the present invention will be readily understood by the skilled person in view of the detailed description below.

### DRAWINGS

The invention will now be described in more detail with reference to the appended drawings, wherein

FIG. 1 discloses schematically a device according to a first embodiment of the present invention;

FIG. 2 discloses schematically a waste receptacle unit of a second embodiment of the invention;

FIG. 3 discloses schematically a drying unit of the first embodiment of FIG. 1,

FIG. 4 discloses schematically a cleaning unit and receiving unit of the first or second embodiment of the invention;

FIG. 5 discloses a third embodiment of the invention;

FIG. 6 discloses the embodiment of FIG. 5 during removal of cassettes for holding human waste;

FIG. 7a-7d disclose a fourth embodiment with a valve in a closed, half-open, and open and blocking state;

FIG. 8 discloses schematically the method according to the invention;

FIG. 9 discloses an embodiment according to a second aspect of the invention;

FIG. 10 discloses schematically a device according to one or more embodiment of the third aspect of the present invention;

FIG. 11 discloses schematically a device according to one or more embodiment of the third aspect of the present invention;

FIG. 12 show a schematic overview of a control unit operating the device according to one or more embodiment of the present invention;

FIGS. 13a and 13b show schematic overviews of the air flow in the device according to embodiments of the present invention;

FIG. 14 is a schematic overview of a device according to embodiments of the present invention; and

FIG. 15 discloses schematically a method according to one or more embodiment of the invention.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

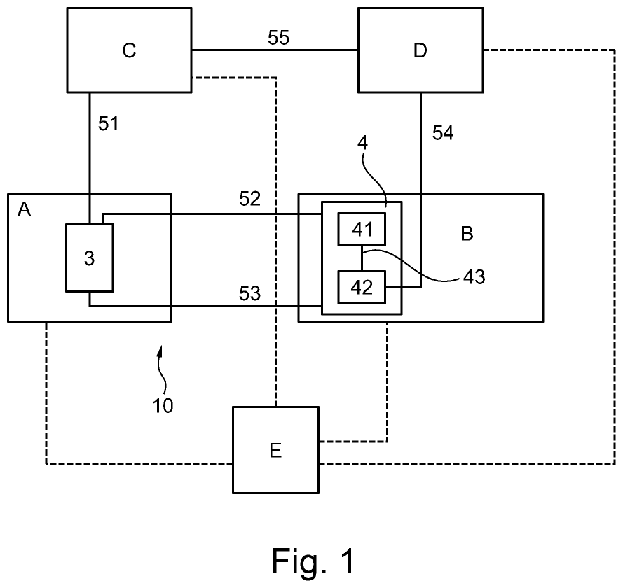

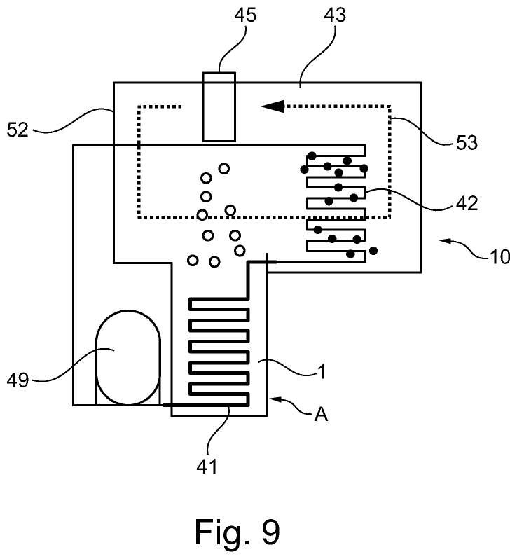

The present invention comprises three main aspects of a device and method for treating human waste. In the following, the first aspect will be described with reference to FIG. 1-8, the second aspect will then be described with reference to FIG. 9, and the third aspect will be described with reference to FIG. onwards. The first and second aspects are similar or identical in most respects but differ from each other in that a heating device is used to heat circulating air in the first aspect and to heat human waste, preferably comprising urine, in the second aspect. The third aspect is also similar or identical to the first and second aspects in most respects but differs in that the cooling device is arranged between the air inlet and the waste receptacle so that air that is introduced through the air inlet is cooled in order to remove moisture before being supplied to the waste receptacle.

It is to be noted that all other features of the present invention is applicable to all three aspects and that what is said of features and benefits of the first aspect may freely be combined with the second aspect or third aspect, and vice versa.

FIG. 1 discloses a first embodiment of the present invention, showing a schematic view of a device 10 for treating human waste. The device comprises a waste receptacle unit A for receiving and holding human waste and a drying unit B that is operatively connected to the waste receptacle unit A so that air from the drying unit B is able to enter and exit the waste receptacle unit A in order to dry human waste held therein. FIG. 1 also discloses optional features of the device 10 in the form of a receiving unit C for receiving human waste from a human and a cleaning unit D for cleaning the receiving unit C. Generally, the receiving unit C is in the form of a toilet seat and toilet bowl into which human waste is introduced before being transported in a waste conduit 51 to the waste receptacle unit A.

The waste receptacle unit A comprises a waste receptacle 3, generally in the form of a container where human waste is held during treatment. Treatment of the waste takes place by air entering the waste receptacle 3 in the waste receptacle unit A through an inlet air conduit 52 and exiting the waste receptacle 3 through an outlet air conduit 53. The drying unit B in turn comprises a heating device 41 connected to the inlet air conduit 52 and a moisture recovery device 42 connected to the outlet air conduit 53. By the heating device 41 also being connected via a connection 43 to the moisture recovery device 42, a circulation of air is achieved in the device 10 where an air stream of heated air enters the waste receptacle 3 and is able to act on the human waste so that moisture is removed and transported in the air stream from the waste receptacle 3 in the outlet air conduit 53. Downstream of the outlet air conduit 53 the air stream passes the moisture recovery device 43 where moisture is removed and is transported through the connection 43 to the heating device 41 again. This enables drying of the waste in the waste receptacle 3 by circulating air so that heating and moisture recovery takes place in an energy efficient way, and by circulating an air flow in the device unpleasant odors in a vicinity of the device 10 are prevented since air is generally prevented from carrying odors from the device 10 into ambient air.

In the first embodiment, the waste receptacle 3 holds human waste in the form of both urine and feces, but in some embodiments separate receptacles are instead used so that urine and feces are treated separately from each other (see below). The heating device 41 and the moisture recovery device 42 may be two separate devices that are connected by the connection 43 but in some embodiments they may instead be integrated into a single component 4 with the connection 43 being an internal connection inside the single component 4 to transport air from the moisture recovery device 43 to the heating device 41. Such a single component may suitably a heat pump where moisture is recovered through condensation. In other embodiments, moisture could instead be removed by chemical binding, for instance using a salt such as potassium chloride or sodium chloride or using another suitable substance such as silica gel (silicone dioxide). Heating could in such embodiments be provided by a heating cartridge or by a heating element or similar that is able to heat an airflow.

The optional cleaning device D is configured to clean the receiving unit C, suitably by spraying a cleaning fluid into the toilet bowl and/or onto the toilet seat and optionally also other parts of the receiving unit C. The cleaning fluid may suitably be water that is captured as recovered moisture in the moisture recovery device 42, 4 and transported to the cleaning device D in a water conduit 54. From the cleaning device D, the cleaning fluid may be transported in a cleaning fluid conduit 55 to the receiving unit C. Optionally, the cleaning device D may be integrated with the receiving unit C, and the water conduit 54 and the cleaning fluid conduit 55 are then integrated into a single conduit that transports fluid from the drying unit B. The cleaning device D will be described in more detail further below.

A control unit E may also be provided for controlling operation of the device 10, and may be operatively connected to each of the waste receptacle unit A, the drying unit B, the receiving unit C, and the cleaning unit D. Alternatively, the control unit E may be operatively connected to only some of them. The control unit E could alternatively be distributed in the device 10 so that at least a part of the control unit E is included in any or all of the waste receptacle unit A, the drying unit B, the receiving unit C, and the cleaning unit D. When it is said that the control unit E is operatively connected to a part of the device 10, this is to be understood as the control unit E being connected in such a way that electrical signals may be passed to and from the control unit E.

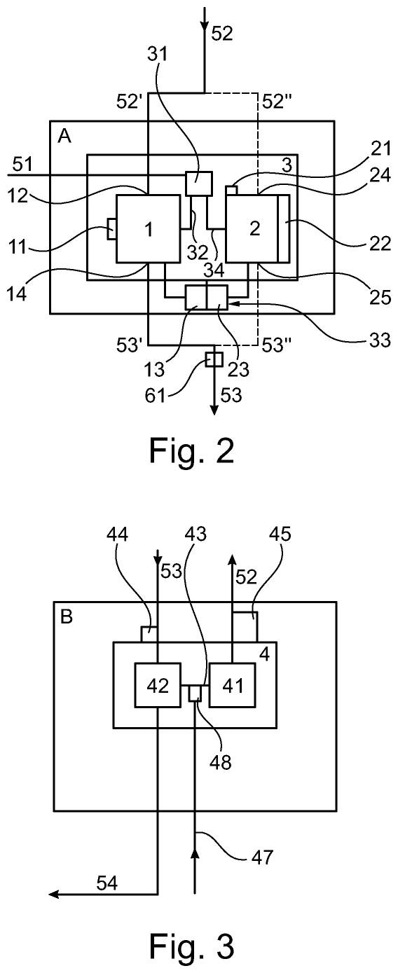

FIG. 2 discloses the waste receptacle unit A in a second embodiment of the invention, where the waste receptacle 3 is divided into a urine receptacle 1 and a feces receptacle 2. In this embodiment, the waste conduit 51 is connected to a separator 31 that separates the human waste into urine that is brought to the urine receptacle 1 via a urine conduit 32 and a feces conduit 34 that is brought to the feces receptacle 2 via a feces conduit 34. In some embodiments, the separator 31 could instead be placed in connection with the receiving unit C and the urine and feces be transported separately from the receiving unit C to the urine receptacle 1 and feces receptacle 2 of the waste receptacle unit A.

Also disclosed in FIG. 2 are a first sensor 11 that is configured to detect moisture in the urine receptacle 1 and a second sensor 21 that is configured to detect moisture in the feces receptacle 2. In some embodiments, only one of these sensors 11, 21 could be used, or alternatively the device 10 could be operated without the aid of sensors 11, 21 at all.

FIG. 2 also discloses a heating element 22 that is arranged in connection with the feces receptacle 2 in such a way that heat from the heating element 22 can be transferred to the feces receptacle 2. The inlet air conduit 52 may branch off into a first inlet air conduit 52′ that connects the inlet air conduit 52 to an inlet 12 of the urine receptacle 1 and a second air conduit 52″ that connects the inlet air conduit 52 to an air inlet 24 the feces receptacle 2. Similarly, the outlet air conduit 53 could be branched off into a first outlet air conduit 53′ and a second outlet air conduit 53″ that connects an air outlet of each of the urine receptacle 1 (air outlet 14) and the feces receptacle 2 (air outlet 25) to the outlet air conduit 53. In some embodiments, the second inlet air conduit 52″ and the second outlet air conduit 53″ could be left out or could comprise valves or other suitable means for selectively closing off and opening the second inlet air conduit 52″ and/or second outlet air conduit 53″. In this way, it can be selected whether feces in the feces receptacle 2 is treated through the heated air flow from the inlet air conduit 52 or through heat from the heating element 22, or both. In embodiments where a waste receptacle 3 is used instead of the urine receptacle 1 and feces receptacle 2, an air inlet and air outlet are provided in the waste receptacle 3 for connecting to the inlet air conduit and the outlet air conduit, respectively.

Also shown in FIG. 2 is a waste collection unit 33 that is configured to receive dried human waste from the waste receptacle 3. Suitably, the waste collection unit 33 may be in the form of a urine collection unit 13 for receiving dried urine from the urine receptacle 1 and a feces collection unit 23 for receiving dried feces from the feces receptacle 2. In some embodiments, dried waste or dried urine and dried feces may be removed from the device 10 by emptying the waste collection unit 33, but alternatively the waste collection unit 33 or the urine collection unit 13 and/or the feces collection unit 23 may be replaceable, preferably in the form of a cassette that can be replaced with a similar cassette to enable continued operation of the device 10. Optionally, at least one of the waste collection unit 33, urine collection unit 13 and feces collection unit 23 may be integrated with the waste receptacle 3, urine receptacle 1 or feces receptacle 2.

FIG. 2 also discloses a capturing device 61 that forms part of the drying unit B and that is suitably arranged in the outlet air conduit 53 or that could alternatively be distributed along the first outlet air conduit 53′ and/or the second outlet air conduit 53″. The capturing device 61 serves to capture particles or gas from the waste receptacle 3, the urine receptacle 1 and/or the feces receptacle 2 to prevent them from circulating in the device 1. It is advantageous to provide the capturing device 61 downstream of the receptacle(s) holding human waste but upstream of the moisture recovery device 42 so that particles and/or gas are removed before being allowed to reach the moisture recovery device 42. The particles may be small fragments of feces that are removed by the air flow passing through the feces receptacle 2 or the waste receptacle 3, or they could also or alternatively be particles that are removed by the air flow passing through the urine receptacle 1 or the waste receptacle 3. Gas may be volatile organic compounds, VOC, or other gas that are released from the human waste during treatment. By capturing particles, a growth of bacteria in the device 10 may be prevented or at least decreased, and by capturing gas odors are prevented from circulating and optionally escaping the device 10 to reach ambient air in the event of the device 10 being opened or in case some part of the circulating air flow is allowed to leave the device 10. Suitably, the capturing device 61 comprises a filter and/or a substance suitable for treating VOC through oxidation or another process that acts to degrade molecules and prevent them from proceeding in the device 10 in their original form. Such a substance may suitably be ozone. The filter may be a carbon filter or a high-efficiency particulate air (HEPA) filter, or may alternatively be a liquid filter. The capturing device 61 may comprise both a filter and a substance or may instead comprise only one of them. In some embodiments, the gas and/or particles may be held in a liquid that is advantageously water recovered in the moisture recovery device 42. In such embodiments, the gas and/or particles may be captured by the air stream passing through a container holding the liquid or alternatively the gas and/or particles may be captured in any other suitable way and then brought into contact with the liquid. In some embodiments, the liquid may be water or another suitable liquid that is able to contain the gas and/or particles but that is not formed by recovered moisture from the moisture recovery device 42.

When the term capture or capturing is used herein, it is to be understood as handling or treating gas or particles, or to make them adhere to a surface or a substance such that they are no longer able to be transported in the airflow in their original form. This can mean being stuck in a filter or treated by a substance such that molecules of the particles or gas are altered or broken down.

In some embodiments of the present invention, the capturing device 61 may also act to capture the gas by applying a substance such as cyclic polysaccharides that serve to encapsulate gas molecules and prevent them from being perceived as carrying an odor. Also, the capturing device 61 may act to prevent odors by applying a scenting agent such as an ester to provide a smell that is perceived as pleasant.

FIG. 3 discloses the drying unit B according to the first embodiments shown in FIG. 1, in which the heating device 41 and the moisture recovery device 42 are two separate components that are connected by the connection 43 so that air is able to flow from the moisture recovery device to the heating device. The Figure also shows that they may alternatively be integrated to form a single component 4 that encompasses both the heating device 41, the moisture recovery device 42 and the connection 43, and this may suitably be realized as a heat pump but alternatively as a thermoelectric generator or another component that is able to realize both heating and moisture recovery.

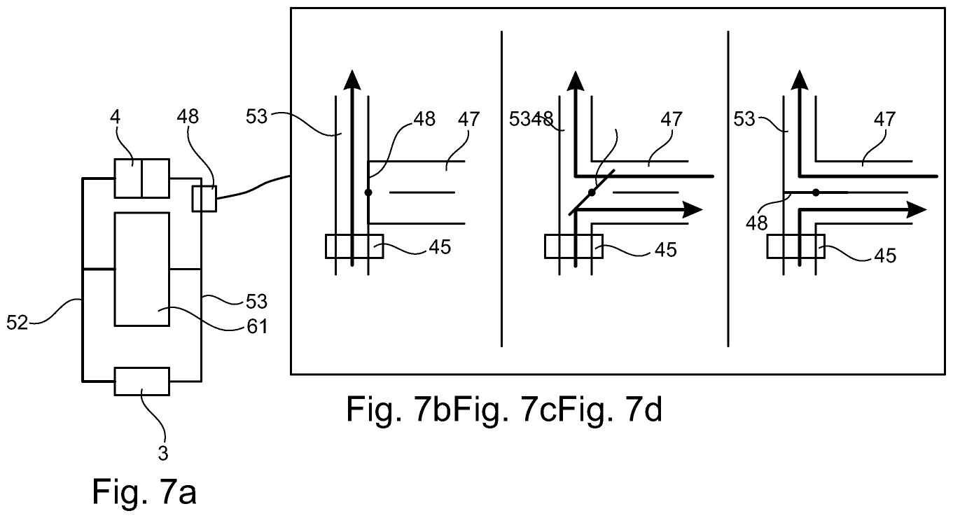

A valve 48 may be provided, in this embodiment in the connection 43 between the moisture recovery device 42 and the heating device 41, but in other embodiments the valve 48 may instead be placed in any other part of the drying unit B that is in connection with the circulating airflow. Optionally, an air supply conduit 47 may also be provided to allow ambient air to reach the valve 48. The purpose of the valve 48 is to supply ambient air into the drying unit B. This may be advantageous both in introducing fresh air into the drying unit B when required and also in allowing for an easy and convenient way of adjusting pressure of the airflow. The use of the valve 48 will be described in more detail further below with reference to FIG. 7.

A third sensor 44 may also be provided in the drying unit B and be placed so that it is able to detect at least one property of the air that flows from the waste receptacle unit A through the outlet air conduit 53 and on to the moisture recovery device 42 or component 4. The third sensor 44 may be configured to detect a property such as humidity or temperature in the air and this information may be used by the control unit E to control operation of the device 10 as described further below. Also, properties of the moisture recovery device 42 may be measured or detected. Such properties may be energy consumption or an amount of recovered moisture, and this may also be used to determine a moisture content of the air coming from the outlet air conduit 53. Furthermore, properties of the heating device 41 may be measured or detected, suitably a temperature or air that arrives through the connection 43 or that leaves the heating device through the inlet air conduit 52.

In this embodiment, the drying unit B forms a closed air loop with the heating inlet air conduit 52, the waste receptacle 3 or the urine receptacle 1 and the feces receptacle 2, the outlet air conduit 53, the moisture recovery device 42, the connection 43, and the heating device 41. By circulating the same airflow in this loop, the device 10 is rendered energy efficient since the same air is heated repeatedly rather than using an intake of ambient air at the heating device 41. This also has the added benefit of keeping the risk of odors at a minimum since contact with ambient air is minimized so any gas given off by the human waste is kept in the closed air loop. As mentioned above, capturing gas and/or particles from the airflow also aids in minimizing the risk of odor in a vicinity of the device 10.

In some embodiments, it may be advantageous to have a continuous intake of ambient air to supplement the airflow already in the device 10. Similarly, it may be advantageous to control a pressure level of the airflow by allowing a controlled quantity of air to exit the device 10, suitably through the water conduit 54 where recovered moisture may be transported from the drying unit B. Efficiency of the device 10 may in some embodiments also be adjusted by changing the pressure of the airflow.

The drying unit B may also comprise an air circulation device 45 for circulating air in the drying unit B. The air circulation device 45 may be arranged in connection with the inlet air conduit 52, but may alternatively instead be arranged in connection with another of the components that form the loop for the airflow in the drying unit B and the waste receptacle unit A. The air circulation device 45 may be a fan. In some embodiments, especially where the component 4 comprising both the heating device 41 and the moisture recovery device 42 is used, the stack effect or chimney effect may instead be used for creating an air flow so that the air is moved in the loop formed by the drying unit B and the waste receptacle unit A. Alternatively, the air flow may be created or increased by selectively altering a density of the air.

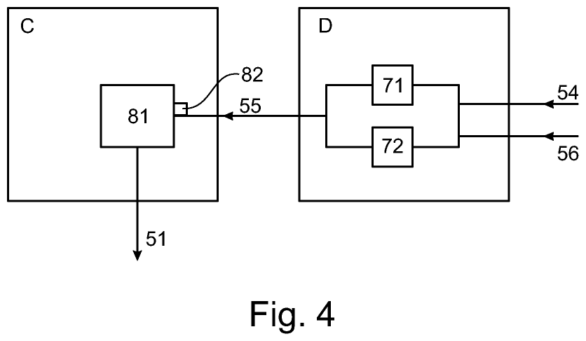

FIG. 4 discloses the cleaning unit D and the receiving unit C according to one embodiment of the invention. The cleaning unit D receives a cleaning fluid either through the water conduit 54 or through a separate cleaning fluid supply 56 that may be a conduit or may alternatively be a container holding an amount of cleaning fluid that is provided in the cleaning unit D or at least connected to the cleaning unit D so that the cleaning fluid can be obtained. The cleaning fluid may be water or may alternatively be any other fluid suitable for cleaning a toilet such as is well known in the art. Suitably, the cleaning device D comprises a steaming unit 71 for heating the cleaning fluid to produce steam, or a pressure unit 72 to pressurize the cleaning fluid, or both. After steaming or pressurizing, the cleaning fluid is transported in the cleaning fluid conduit 55 to the receiving unit where it is suitably sprayed through at least one nozzle into at least one part 81 of the receiving unit C. That part may be a toilet bowl, a toilet seat, or any other part connected to the toilet bowl or toilet seat. In some embodiments, a plurality of nozzles 82 may be used to spray the cleaning fluid into one part or several of the receiving unit C. In some embodiments, the cleaning fluid may be applied to the receiving unit C without first being steamed or pressurized, and may in such cases be used to flush or rinse the receiving unit C.

It is advantageous to use the recovered water from the moisture recovery unit 42 as cleaning fluid since this allows the device 10 to be independent of any water supply. By heating the water to produce steam, any bacteria present in the receiving unit C are efficiently reduced so that bacterial growth may be avoided. By pressurizing the cleaning fluid, a more efficient cleaning is also achieved.

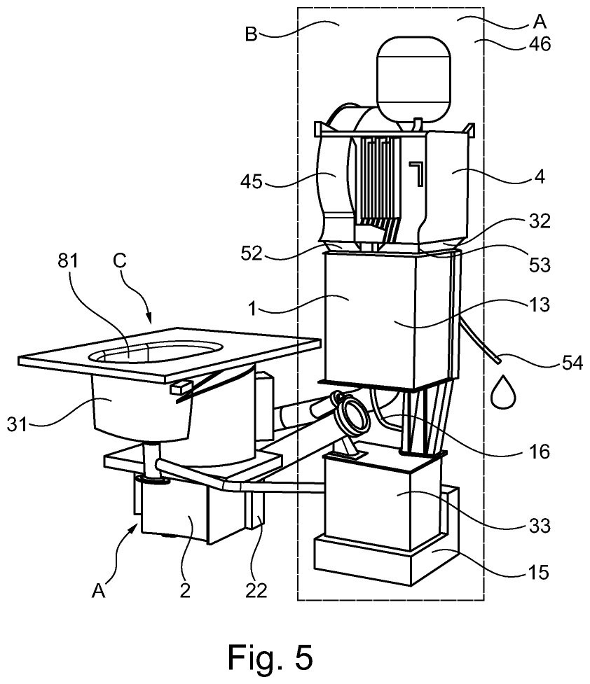

FIG. 5 discloses a third embodiment of the invention with a casing 46 that encases the drying unit B and parts of the waste receptacle unit A. The receiving unit C comprises the toilet seat and toilet bowl, and the separator 31 is in this embodiment comprised in the toilet bowl. From the separator 31, urine is transported to a buffer tank 15 from which it is supplied to the urine receptacle 1 that is in this embodiment integrated with the urine collection unit 13 and is in the form of a cassette with a surface maximizing absorbent material made from a biodegradable material, suitably cellulose. The material is arranged to form funnels through which the air flow may pass, and the urine is supplied through the urine conduit and allowed to flow over the absorbent material in the cassette. A pump may be provided for transporting the urine from the buffer tank 15 to the urine receptacle 1 and may be activated to supply additional urine to the urine receptacle 1 when a predetermined moisture level in the urine receptacle is reached. In this way, smaller quantities of urine may be dried and new urine supplied as soon as the drying of a previous quantity is finished or has reached a level where it is considered suitable to continue supplying urine. In some embodiments, a material that is not biodegradable may instead be used and the cassette may in such embodiments be disposed of along with other household waste or the cassette may be emptied so that its contents may be removed and used as fertilizer or for other suitable purposes.

In this embodiment, the device 10 also comprises drip line 16 from the urine receptacle 1 to the buffer tank 15 so that urine that is not captured by the absorbent material in the urine receptacle 1 may be guided back to the buffer tank 15. This is especially advantageous in embodiments that do not comprise the first sensor 11 so that the moisture currently present in the urine receptacle 1 is unknown. In this way, a very cost efficient and reliable solution is achieved where urine is simply pumped into the urine receptacle 1 at a rate that is considered suitable, for instance by adding a predetermined quantity or urine at predetermined intervals or by constantly supplying small amounts of urine. Any superfluous urine is then gathered at a bottom of the urine receptacle 1 and allowed to return to the buffer tank 15.

The heating device and moisture recovery device are in this embodiment in the form of a heat pump 4, and air circulation means 45 in the form of a fan is also included to generate or increase the airflow. By providing the air inlet conduit 52 and air outlet conduit 53 to and from the urine receptacle 1, a circulation of air is achieved that acts to dry the urine in the cassette 13. Recovered water is ejected through the water conduit 54 and may be connected to a cleaning device D as described above or may alternatively be gathered in another way or simply allowed to drip out of the device 10.

From the separator 31, feces are transported to the feces receptacle 2 that is in this embodiment provided below the toilet bowl. The circulating air flow is not used for drying the feces as well; instead, the heating element 22 is provided in connection with the feces receptacle 2 and serves to provided sufficient heat to dry the feces. Once dry, the feces are transported into the feces collection unit 33 that is in the form of a box or bag and that may suitably also be made from a biodegradable material such as cellulose.

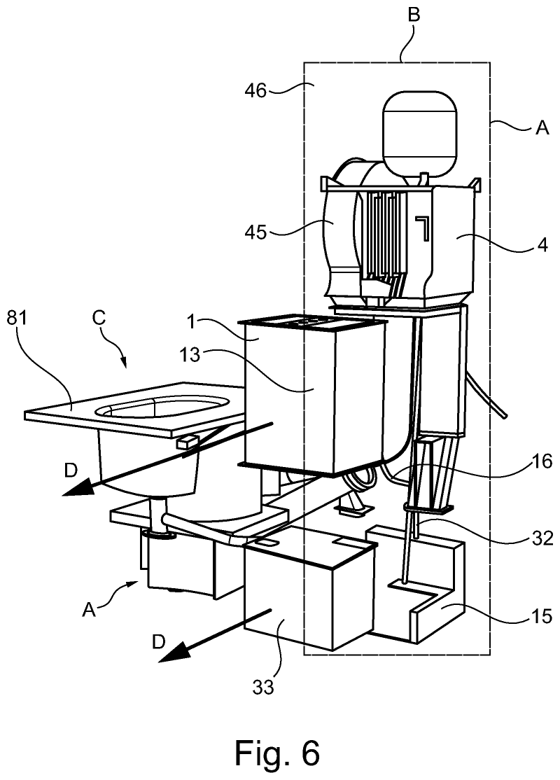

FIG. 6 discloses the embodiment of FIG. 5 and shows how the cassettes forming the urine receptacle 1/urine collection unit 13 the feces collection unit 33 may be replaced. By holding each of the urine collection unit 13 and feces collection unit 33 and pulling them in a direction D shown by the arrows, the dried urine and feces are removed in a convenient and reliable way. To replace them, new cassettes that have not yet been used are inserted in a direction opposite to the direction D in which the cassettes were removed.

The used cassettes may be used as fertilizer where the biodegradable material is degraded so that nutrients present in the dried urine and feces are released. Alternatively, the used cassettes may be disposed of in household waste or in any other suitable way. Also, the cassette used as urine receptacle 1 may be used to trap material or substances from the urine such as nitrogen compounds or potentially harmful material such as drugs that are released from a human body dissolved in urine.

FIG. 7a-d discloses an embodiment of the invention using the valve 48 to selectively introduce ambient air into the device 10. In FIG. 7a, placement of the valve 48 upstream of the component 4 comprising the moisture recovery device 42, the connection 43 and the heating device 41 is schematically shown, along with the waste receptacle 3 and the input air conduit 52 and output air conduit 53. Also provided is the capturing device 61 and it is in this embodiment connected in series with the waste receptacle 3 and the component 4 so that a portion of the air in the outlet air conduit 53 having passed through the waste receptacle 3 may bypass the component 4 and instead pass through the capturing device 61 that is preferably in the form of a filter.

FIG. 7b discloses the outlet air conduit 53, the valve 48 and the air supply conduit 47 in more detail, together with the air circulation device 45 that serves to direct air as shown by an arrow in the figure. In this figure, the valve 48 is in a closed state so that air is circulated in the device 10 without contact with ambient air.

FIG. 7c discloses the valve 48 in a half-open state that allows both an exhaust of a portion of the airflow in the outlet air conduit 53 and an intake of ambient air to replenish the airflow to the component 4. This state is particularly advantageous in situations where ambient air has a higher temperature than the airflow in the outlet air conduit 53, since an intake of the ambient air will then save energy required for heating the air in the heating device 41.

FIG. 7d discloses the valve 48 in an open and blocking state, where the entire airflow in the outlet air conduit 53 is directed out through the air supply conduit 47 and ambient air is introduced to replace the airflow in the outlet air conduit 53 downstream of the valve 48. This state is advantageous in situations such as that shown by FIG. 6 where the urine collection unit 13 and/or feces collection unit 23 are removed and replaced, since the valve 48 in the open and blocking state acts to create a negative pressure in the device that prevents odor from escaping as the cassettes are replaced.

As shown in FIG. 1, the device 10 may also comprise a control unit E that is configured to communicate with other parts of the device 10 by receiving and sending signals. The control unit E may be a separate unit but may alternatively be distributed in the device 10 so that functions of the control unit E are included in other parts of the device 10.

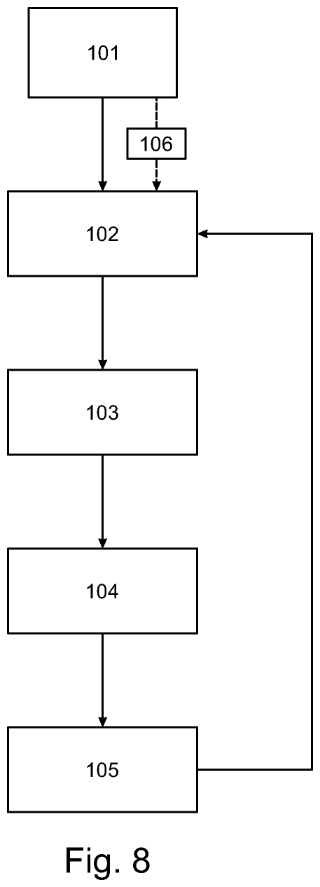

The method for treating human waste according to the invention will now be described in more detail with reference to FIG. 1-7 as described above and also with reference to FIG. 8.

Human waste is entered into the waste receptacle unit A of the device 10 in any suitable way, such as by being received by a receiving unit C and transported into the waste receptacle 3 or the urine receptacle 1 and feces receptacle 2.

the device 10 comprising the drying unit B and the waste receptacle unit A is thus provided 101 and air that is held in the drying unit B is heated 102 by a heating device 41 comprised in the drying unit B. The heated air is supplied 103 to the waste receptacle unit A in order to dry human waste that is held in the waste receptacle unit A. The air is then transported 104 from the waste receptacle unit A and moisture is recovered 105 by the air being subjected to a moisture recovery device 42 in the drying unit B. This lowers a moisture content in the air so that it may again be used to dry human waste. The method is then repeated so that the air is again heated 102, supplied 103 to the waste receptacle unit A, transported 104 from the waste receptacle unit A and dried by moisture being recovered 105.

Treating (i.e. drying) the human waste by blowing heated dry air through the waste receptacle unit A is performed until it is deemed that the human waste is dry. This can be decided by selecting a given time that is considered sufficient for drying the waste, either using a predetermined time or by deciding on a suitable time depending on a property of the human waste itself. That property can be the presence of either urine or feces or both, or it can alternatively be a weight or volume of the human waste received.

Alternatively, sensors such as the first sensor 11 and second sensor 21 may be used to detect or measure a property such as a moisture content or humidity inside a waste receptacle 3, urine receptacle 1 and/or feces receptacle 2, or alternatively a humidity in the output air conduit 53 or in another part of the device 10 that is in fluid communication with the output air conduit 53, or alternatively a weight of waste compared to an original weight detected or measured previously. Also, a property of the moisture recovery device 42 such as an amount of energy needed to remove moisture or a quantity of water removed may be detected and/or measured. A combination of these or other properties that indicate a dryness of the human waste may also be used. It is to be noted that urine may be considered dry even when it is still perceived as a liquid as long as a predetermined threshold for moisture content, rate of change of moisture content, weight, or other property of the device 10 is met or fulfilled. Selecting the predetermined threshold or the property may advantageously be based on conditions where the waste (i.e. the urine and/or feces) is deemed sufficiently dry or where it is determined that removal of further moisture is difficult or impossible.

Operation of the drying unit B may be continued until a measured or detected property reaches a predetermined threshold, such as a humidity being below a given value or alternatively until a rate of change of the property reaches a given value. This would indicate that the human waste is dry, and operation of the drying unit B is interrupted. In an advantageous embodiment, the threshold is a moisture threshold or a rate of change threshold of relative humidity in the airflow.

In an advantageous embodiment, the threshold is instead a weight threshold where the at least one sensor such as the first sensor 11, the second sensor 21 or another sensor provided in connection with the waste receptacle unit A detects or measures a weight of waste in the waste receptacle 3 or in the urine receptacle 1 and/or feces receptacle 2. The predetermined threshold is suitably that the weight of the waste or of the urine or feces has decreased to a given proportion of an original weight detected or measured when the waste first entered the waste receptacle 3 or the urine receptacle 1 and/or feces receptacle 2. Suitably, the predetermined threshold is at least 90% for urine in the urine receptacle 1 and at least 40% for feces in the feces receptacle 2, or alternatively at least 50% for waste in the waste receptacle 3. In some embodiments, the predetermined threshold may be higher such as 95% or even 99% for urine and 50% or even 60% for feces.

In some embodiments, operation of the drying unit B may also be interrupted every time a user uses a receiving unit C that is connected to the waste receptacle unit A, so that a person opening a lid on the receiving unit C or sitting down on the toilet seat causes the drying unit B to stop. This allows for the waste conduit 51 to be open in order to convey human waste into the waste receptacle unit A and also for the waste conduit 51 to be closed when the user is finished so that the circulating airflow in the drying unit B does not escape the device 10 through the receiving unit C. In the preferred embodiment, the drying unit B forms a closed air loop during operation.

In some embodiments, the human waste is separated 106 so that urine is transported into the urine receptacle 1 and feces into the feces receptacle 2 before being treated by the drying unit B. The airflow of the drying unit B may in such embodiments be supplied to both the urine receptacle 1 and the feces receptacle 2 or only to the urine receptacle 1. If the feces are not treated by the airflow of the drying unit B, it may instead be dried by the heating element 22 or may only be stored for subsequent disposal.

When the urine is dried, at least one material may be collected from the urine receptacle 1 or from the urine collection unit 13. This material may be nutrients such as nitrogen compounds that may be used as fertilizer but is may also be substances such as drug residues.

After the airflow has passed through the waste receptacle 3 or urine receptacle 1 and possibly feces receptacle 2, it may pass the capturing device 61 so that gas such as volatile organic compounds, VOC, and/or particles from the human waste may be captured. Preferably, the capturing device 61 is arranged downstream of the waste receptacle 3 (or urine receptacle 1 and/or feces receptacle 2) but upstream of the moisture recovery device 42 so as to prevent gas an particles from reaching the moisture recovery device 42.

When using the device 10 according to the invention, human waste is received into the waste receptacle unit A and the drying unit B is operated until it is deemed that the waste is dry. The operation of the device is then interrupted and resumed once more waste has been added. In the embodiment of FIG. 5-6, urine is inserted little by little into the urine receptacle 1 and drying proceeds until the buffer tank 15 is empty or until a predetermined quantity of urine has been dried. Meanwhile, feces are dried by the heating element 22 and transported into the feces collection unit 23 when deemed sufficiently dry. The control unit E may control these processes or alternatively a user may manually activate the drying unit B and/or the heating element 22 when needed, or they may operate continuously, optionally with interruption only when a user sits on the toilet seat. The device 10 may comprise an indicator that indicates that the urine collection unit 13 and/or feces collection unit 23 need replacing, or alternatively they can be replaced at regular intervals or when deemed suitable by the user.

When removing the urine collection unit 13 and/or feces collection unit 23, the cassette(s) is/are taken out of the device 10. Advantageously, operation of the drying unit B is interrupted before removing the cassettes so that addition of dried waste or waste being treated is prevented when the device 10 is open and the cassettes are removed. This may in some embodiments be controlled by operation of the drying unit B being interrupted when the casing 46 is opened or when a holder fixing the cassette(s) in place is released. After inserting new cassette(s), operation of the drying unit B may continue. The valve 48 may be provided for allowing ambient air to enter the device 10 when the cassette(s) is/are removed so that a negative pressure is created, and the valve 48 may be operated in the same way as operation of the drying unit B is interrupted.

A negative pressure in the device 10 may also be created by air from the airflow inside the drying unit B being ejected from the device 10, suitably together with water being ejected from the moisture recovery device 42.

Cleaning of the receiving unit C may be scheduled to take place at regular intervals or alternatively at least one sensor may detect or measure that the receiving unit C is dirty and should be cleaned. Manually activated cleaning is also possible and could also be combined with cleaning at regular intervals or cleaning when needed. The cleaning may be performed by the device 10 itself by cleaning fluid being applied to the receiving unit C as desired, or alternatively the user may perform the cleaning. Nozzles for spraying cleaning fluid may be provided stationary in the receiving unit C or may alternatively or additionally be provided on a cleaning handle that is manually operated and that may be inserted into the receiving unit in order to be able to spray cleaning fluid as desired.

The control unit E may be configured to perform some or all of the method described above for operating the device 10 to treat human waste.

FIG. 9 discloses an embodiment of the second aspect of the invention that differs from the first aspect described above by the heating device not applying heat to the airflow but instead to urine in the waste receptacle unit. In most features apart from the heating being applied to a liquid instead of to air, the fifth embodiment is similar to the other embodiments described herein and it is especially to be noted that features from the first aspect may be combined with features from the second aspect within the scope of the present invention.

Thus, FIG. 9 discloses the device 10 for treating human waste, with a waste receptacle unit A in which human waste is held. In FIG. 9, the waste receptacle unit A is shown to comprise a urine receptacle 1 but it could also be the waste receptacle 3 described above with reference to the first aspect. It is advantageous that the waste to which heat is applied comprises urine since this will allow for an efficient heating but in some embodiments heat from the heating device 41 could instead be applied to feces in the feces receptacle 2. As shown in FIG. 9, air is supplied to the urine receptacle 1 through the inlet air conduit 52 and heat from the heated waste in the waste receptacle unit A is transported by the airflow to the moisture recovery device 42 that is arranged in connection with the outlet air conduit 53. Air is then circulated by passing the connection 43 and entering the inlet air conduit 52 again. Suitably, the air circulation device 45 is also provided in order to circulate air in the device 10. The heating device 41 is in this embodiment provided in the form of a heating coil inside the urine receptacle 1 and the moisture recovery device 42 is in the form of a cooling coil in the outlet air conduit 53 such that moisture in the air passing the cooling coil is condensed. Also provided is a compressor 49 in connection with the heating coil and the cooling coil.

The method according to the second aspect of the invention differs from the method according to the first aspect described above in that heating is applied to the human waste directly and that moisture is passed to the airflow through evaporation from the urine receptacle 1 or waste receptacle. Air is then circulated by being transported from the outlet air conduit 53 to the inlet air conduit 52 without being heated. In all other respects, the method according to the second aspect is similar or identical to the method according to the first aspect.

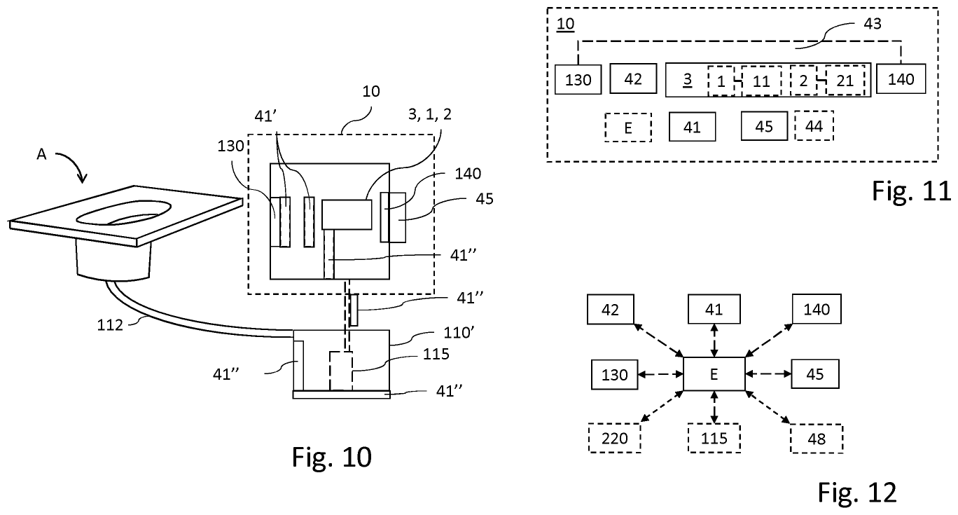

The third aspect will now be described with reference to FIG. 10 onwards.

### Device Embodiments

Turning first to FIGS. 10 and 11, there is shown a schematic overview of the device 10 for treating human waste, the device comprising an air intake 130 for passing incoming air Air_{IN} into the device 10, an air outlet 140 for passing outgoing air Air_{OUT} out from the device 10, the moisture recovery device 42 for cooling air, thereby recovering moisture from the air, the waste receptacle 3 for holding human waste and the heating device 41 configured to heat human waste comprised in the device 10. The device 10 further comprises the air circulation device 45 configured to generate an airflow in the device 10 in a flow direction FD. The device 10 is configured to convey air in the flow direction FD from the air intake 130 to the moisture recovery device 42, from the moisture recovery device 42 to the waste receptacle 3 and from the waste receptacle 3 to the air outlet 140. Through the advantageous combination of cooling of air and heating of waste thus obtained, the device 10 is configured to dry or at least reduce the moisture content in human waste in an energy efficient manner, and to produce as an end result a dried or partially dried waste concentrate rich in nutrients which may be recovered. The waste receptacle 3 is connected to or integrated with a waste receptacle unit A that may also comprise a pre-treatment receptacle 3′.

In some embodiments, the human waste 160 may be transported directly to the waste receptacle 3 but in other embodiments the waste may first be held in the pre-treatment receptacle 3′ where optionally heating may be supplied as is described further below.

In one or more embodiment, the waste receptacle 3 and optionally also other parts of the device 10 may be located at a height above the receiving unit A and waste 160 is then transported to the waste receptacle against the direction of the force of gravity. Suitably, by a waste transporting device 115 being able to lead waste (liquid urine, feces, mix, concentrate) against the direction of the force of gravity, a larger freedom in the arrangement of the components of the device 10 and components connected thereto is obtained, since gravity does not have to be used for leading waste to the waste receptacle for moisture removal. This means that the device 10 and components connected thereto may be optimized with regards to size and/or more easily adapted to conform to a given space in which it is to be mounted.

The waste transporting device 115 may be located inside the waste pre-treatment receptacle 3′ or external to and downstream of the waste pre-treatment receptacle 3′. Preferably the waste transporting device 115 is a pump, but other alternatives such as capillary forces also work. In another example, the waste transporting device 115 may comprise one or more vaporization device, and/or Archimedean screw, water wheel or other device for mechanically transporting liquid, such as urine, or matter comprising liquid, such as feces, a mix of feces and urine, or a concentrate from urine, feces, or a mix thereof. In other embodiments, the waste transporting device 115 could comprise a device utilizing pressure differences for liquid transportation. Any suitable combination of these alternatives may also be used.

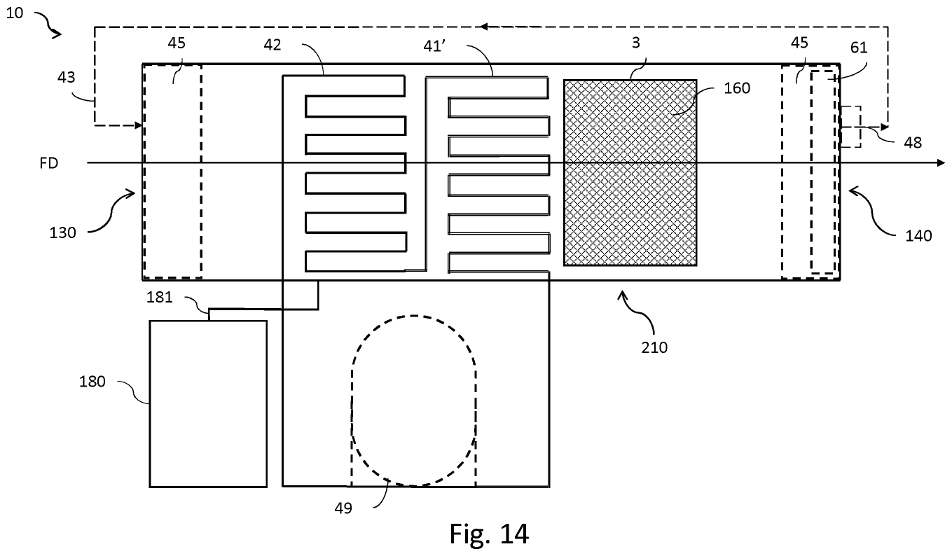

As indicated in FIGS. 10 and 14, the waste receptacle 3 may in one or more embodiments comprise the urine receptacle 1 and/or the feces receptacle 2. In different embodiments, the term waste is herein used to describe either urine, urine concentrate, feces, feces concentrate, a mix of urine and feces, or a concentrate of a mix of urine and feces. The waste receptacle 3 may further comprise the separator for separating human waste into the urine receptacle 1 and the feces receptacle 2.

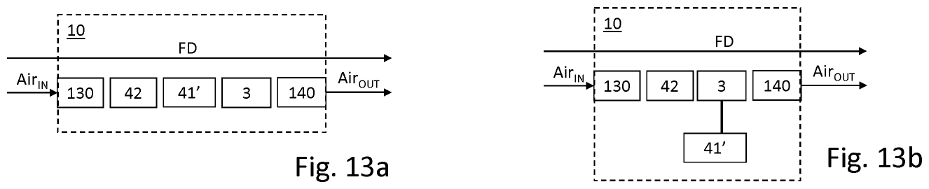

The heating device 41 may be configured to heat human waste comprised in the device via a medium. One or more heating device 41 may advantageously be arranged in suitable location(s) in the device 10 for heating human waste, as illustrated by the exemplary locations for heating devices 41′, 41″ and 41′″ in FIGS. 10 and 13a-b. In some embodiments, the medium is air and the heating device 41 is arranged downstream of the moisture recovery device 42 and upstream of the waste receptacle 3 in the flow direction FD, such that the heating device 41 heats the air cooled by the moisture recovery device 42 before the air passes through the waste receptacle 3. A schematic view of such an arrangement is shown in FIG. 13a, showing a heating device 41′ that by the airflow in the device 10 in the flow direction FD receives cooled, dry air from the moisture recovery device 42 and heats this dry air before it passes through the waste collecting receptacle 110. The heating device 41′ arranged in the same location in the flow direction FD is also shown in FIG. 14. When passing through the waste receptacle the dry, heated air heats human waste held there, thereby increasing the rate and efficiency of evaporation of moisture comprised in the waste, and hence the dehydration efficiency of the device 10.

Alternatively, or in combination, the device 10 may comprise the waste receptacle 3, and the heating device 41 may be arranged in or otherwise operatively connected to the waste receptacle 3 for heating human waste and/or air comprised therein. A schematic view of such an arrangement is shown in FIG. 13b, showing a heating device 41′ that is arranged in or otherwise operatively connected to the waste receptacle 3 and thereby arranged to heat waste 160 comprised in the waste receptacle 3 either directly, or indirectly by heating the air in the waste receptacle 3 and causing moisture comprised in the waste to evaporate, in the waste receptacle and/or after the waste has been put into contact with the waste receptacle. The embodiment of FIG. 13b and the additional embodiment of FIG. 10 relating to heating device 41′ also advantageously combines cooling and drying of air before it is passed into the waste receptacle with heating of the waste to cause moisture comprised in the waste to evaporate. Thereby, the rate and efficiency of evaporation of moisture comprised in the waste, and hence the dehydration efficiency of the device 10, is increased.

Any combination of heating the medium air using a heating device 41′, heating the waste receptacle 3 directly and/or preheating the waste held in the pre-treatment receptacle 3′ may also be applied, to obtain an even further increased rate of removal of moisture from the waste comprised in the device 10. Different combinations may also provide a maximized energy efficiency depending on the design and arrangement of the components in and connected to the device 10.

The moisture recovery device 42 may be configured to dry the air by condensing (fluidifying) water comprised in the air, thereby recovering moisture from the air and at the same time increasing the drying capacity of the air. Turning now to FIG. 14, the moisture recovery device 42 may in one or more embodiment comprise at least cooling coil, as illustrated in FIG. 14, and/or at least one cooling baffle. The heating device 41 may similarly comprise at least heating coil, as illustrated in FIG. 14, and/or at least one heating baffle. The heating device 41 and the moisture recovery device 42, or moisture recovery device 120, may be two separate devices, but in some embodiments they may instead be integrated into a single component. Such a single component may suitably be a heat pump where moisture is recovered through condensation but may alternatively be realized as a thermoelectric generator or another component that is able to realize both heating and moisture recovery. Thereby, condensation and heating may be provided in an integrated device so that the drying is rendered efficient while at the same time being energy efficient. In other embodiments, moisture could instead be removed by chemical binding, for instance using a salt such as potassium chloride or sodium chloride or using another suitable substance such as silica gel (silicone dioxide). Heating could in such embodiments be provided by a heating cartridge or by a heating element or similar that is able to heat an airflow. The moisture recovery device 42 and heating device 41 may be connected to a compressor 49. In the non-limiting embodiment wherein the moisture recovery device 42 and the heating device 41 are part of a heat pump, also comprising the compressor 49, reject heat generated during operation of the compressor may further be retrieved and introduced, for example via a reject heat conduit (not shown in the figure), into the waste pre-treatment receptacle 3′ and used for further heating of the human waste comprised therein, either directly or via the air comprised in the waste pre-treatment receptacle 3′.

In one or more optional embodiments, as illustrated in FIGS. 11 and 14, the device 10 may form a closed air loop such that air passes the moisture recovery device 42, the heating device 41 if this is arranged in the airflow, the waste receptacle 3 and the moisture recovery device 42 again during operation of the device 10 without contact with ambient air, in a circular airflow. To this end the device 10 may further comprise a connection 43 for transporting air from the air outlet 140 to the air intake 130, such that air is circulated in the device 10.

As illustrated in FIG. 14 the device 10 may further comprise a capturing device 61 for capturing particles and/or volatile organic compounds, VOC, from the air. The capturing device 61 may preferably be located in or operatively connected to the air outlet 140 for capturing particles and/or VOC from the air after it has passed through the waste receptacle 3. Thereby, particles and gas that have been released from the human waste may be captured to prevent them from circulating and contaminating the device 10, in embodiments where a circulating airflow is applied, and also to prevent odor from escaping the device 10 so that unpleasant smells are avoided. The capturing device 61 may comprise a filter that is arranged in or operatively connected to the air outlet 140 such that the air passes through the filter. This is a particularly efficient way of achieving the capture of particles and gas.

Turning again to FIG. 14, the device 10 may further comprise a vacuum chamber 210 enclosing the waste receptacle 3, the moisture recovery device 42, the waste receptacle 3 and the heating device 41, and a vacuum pump 220 for generating a vacuum in the vacuum chamber 210, the vacuum pump being operatively connected to the vacuum chamber 210.

In one or more embodiment, as shown in FIGS. 11-12, the device 10 may comprise a control unit E for operating the device 10. The control unit E is in these embodiments configured to communicate with and optionally control the operation of other parts of the device 10 by receiving and sending signals. As schematically illustrated in FIG. 3, the control unit E may be operatively and/or communicatively connected to each of the moisture recovery device 42, the air intake 130, the air outlet 140, the optional one or more valve 48, the heating device 41, the air circulation device 45 and the optional vacuum pump 220. Alternatively, the control unit E may be operatively and/or communicatively connected to only some of them. The control unit E could alternatively be distributed in the device 10 so that at least a part of the control unit E is included in any or all of the moisture recovery device 42, the air intake 130, the air outlet 140, the optional one or more valve 48, the heating device 41, the air circulation device 45 and the optional vacuum pump 220. When it is said that the control unit E is operatively and/or communicatively connected to a part of the device 10, this is to be understood as the control unit E being connected in such a way that electrical signals may be passed between (to and from) the control unit E and each of the one or more other parts of the device 10 that are to be controlled.

The device may further comprise at least one sensor for determining a moisture content of human waste in the waste receptacle 3, urine receptacle 1 and/or feces receptacle 2, wherein the at least one sensor is operatively connected to the control unit E. Also disclosed in FIG. 11 are a first sensor 11 that is configured to detect moisture in the urine receptacle 1 and a second sensor 21 that is configured to detect moisture in the feces receptacle 2. In some embodiments, only one of these sensors 11, 21 could be used, or alternatively the device 10 could be operated without the aid of sensors 11, 21 at all.

As further shown in FIG. 11, a third sensor 44 may also be provided in the device 10 and be placed so that it is able to detect at least one property of the air that flows from the waste receptacle 3 to the air outlet 140, i.e. the outgoing air Air_{OUT}. The third sensor 44 may be configured to detect a property such as humidity or temperature in the air and this information may be used by the control unit E to control operation of the device 10 as described further below. Also, properties of the moisture recovery device 42 may be measured or detected. Such properties may be energy consumption or an amount of recovered moisture, and this may also be used to determine a moisture content of the incoming air Air_{IN}. Furthermore, properties of the heating device 41 may be measured or detected, suitably a temperature of air that arrives at the heating device 41 or that leaves the heating device 41.

Turning again to FIG. 11, to control the waste handling process of the device 10, the control unit E may be communicatively connected to and configured to control functions of one or more components of the device 10 that affect the moisture removal, or dehydration, rate, such as the moisture recovery device 42, the heating device 41, the air intake 130, the air outlet 140, the air circulation device 45, the optional waste transporting device 115, and/or the optional vacuum pump 220.

In one or more embodiments, the control unit E may be configured to control the waste transporting device 115 to lead waste from the waste pre-treatment receptacle 110 at a controlled rate. The controlled rate may in these embodiments be pre-set, or it may be based on information received in and processed by the control unit E.

In one or more embodiments, the control unit E may be configured to control the intake of air via the air intake 130 and/or outlet of air via the air outlet 140, e.g. by controlling opening and closing of one or more thereto associated valve(s) 48. Controlling the air intake and/or outlet may in these embodiments be pre-set, or it may be based on information received in and processed by the control unit E.

As further shown in FIG. 11, the device 10 may comprise or be communicatively connected to at least one sensor 11, 21, 44. Each of the at least one sensor 11, 21, 44 may be configured to measure a dehydration related parameter, and the control unit E is in these embodiments configured to obtain (e.g. by receiving or retrieving) the one or more measured dehydration related parameter from one or more of the at least one sensor 11, 21, 44 and control the waste handling, preferably the moisture removal or dehydration rate, in the device 10 based on the obtained one or more measured dehydration related parameter. In other words, information received in and processed by the control unit E comprises sensor measurement data in the form of the one or more measured dehydration parameter and the control unit E is in these embodiments configured to control the functions of one or more component of the device 10 based on this sensor measurement data.

As shown in FIG. 10, condensed water or moisture recovered from the air by operation of the moisture recovery device 42 may be led in a recovered moisture conduit 181 connecting the device 10 to a recovered moisture receptacle 180 configured to receive and hold recovered moisture. The recovered moisture held in the recovered moisture receptacle 180 may then be used for cleaning the receiving unit. To this end, the device 10 may also comprise the cleaning device C for cleaning the receiving unit. The cleaning device suitably comprises at least one nozzle for spraying a cleaning fluid into the receiving unit. Thereby, the receiving unit that may typically be a toilet bowl that is available to a user, can be cleaned as desired in order to remain clean and user friendly. Suitably, the cleaning device may be operatively connected to the device 10 for receiving recovered moisture from the recovered moisture receptacle 180, and the cleaning fluid may be said recovered moisture. Thereby, the device 10 may be operated, and the receiving unit cleaned without needing access to an external water supply, or at least with reduced need of the addition of external water. This is especially advantageous in locations or areas where access to water is limited.

Also, the cleaning device may comprise a steaming unit for heating the cleaning fluid to produce steam and the at least one nozzle may be configured for spraying steam into the receiving unit for cleaning. Thereby, steam may be used to disinfect the receiving unit so that bacterial growth is avoided.

In another embodiment that is closely related to the third aspect of the invention, the same components as in the third aspect are used but the moisture recovery device 42 is arranged downstream of the waste receptacle 3 so that air passes from the air intake 130 to the waste receptacle 3 and further onwards to the moisture recovery device 42 before being taken to the air outlet 140. In this embodiment, a circular flow may also be provided by connecting the air outlet 140 to the air inlet 130 so that the air is reintroduced into the waste receptacle 3. The alternatives and features of the first, second and third aspects mentioned above may also be combined with this embodiment.

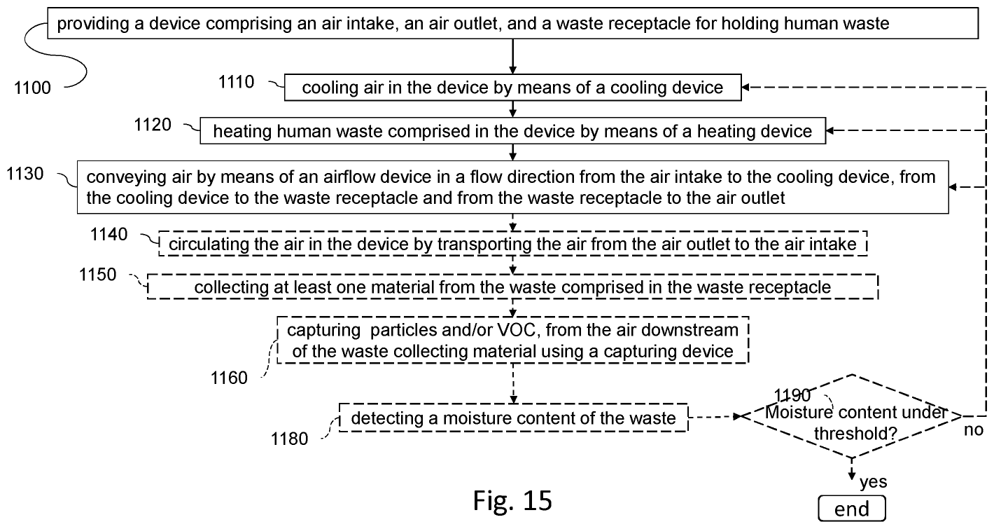

The method for treating human waste according to the third aspect of the invention will now be described in more detail with reference to FIG. 10 onwards and in particular FIG. 15. In one or more embodiment, the method comprises:

In step 1100: providing a device 10 comprising an air intake 130 for passing incoming air Air_{IN} into the device 10, an air outlet 140 for passing outgoing air Air_{OUT} out from the device 10, and a waste receptacle 3 for holding human waste.

In step 1110: cooling air in the device 10 by means of a moisture recovery device 42, thereby recovering moisture from the air.

Step 1110 may suitably comprise removing moisture from the air through condensation by cooling the air in the device 10 by means of the moisture recovery device 42.

In step 1120: heating human waste comprised in the device 10 by means of a heating device 41.

Heating human waste comprised in the device 10 by means of the heating device 41 may comprise heating human waste via a medium. In some embodiments, the medium is air and heating human waste comprised in the device 10 by means of the heating device 41 is done downstream of the cooling of air in the device 10 by means of the moisture recovery device 42 and upstream of the waste receptacle 3 in the flow direction FD, such that the air cooled by the moisture recovery device 42 is heated before the air passes through the waste receptacle 3.

Alternatively, or in combination with any of the embodiments above, heating human waste comprised in the device 10 by means of the heating device 41 comprises heating human waste or air in the waste receptacle 3 comprised in the device 10.

In step 1130: conveying air by means of an air circulation device 45 in a flow direction FD from the air intake 130 to the moisture recovery device 42, from the moisture recovery device 42 to the waste receptacle 3 and from the waste receptacle 100 to the air outlet 140.

Step 1130 may further comprise selectively introducing ambient air into the device 10 by means of one or more valve 48.

It should be noted that steps 1100, 1120 and 1130 may be performed in any order during operation of the device 10, serially or in parallel, within the framework of embodiments presented herein.

In different embodiments, the method may further comprise a combination of any or all of the optional steps 1140-1190, comprising:

In optional step 1140: circulating the air in the device 10 by transporting the air via a connection 43 from the air outlet 140 to the air intake 130.

Optional step 1140 may comprise conveying air in a closed air loop such that air passes the moisture recovery device 42, the heating device 41 if this is arranged in the airflow, the waste receptacle 3 and the moisture recovery device 42 again during operation of the drying unit without contact with ambient air.

Step 1140 may further comprise selectively introducing ambient air into the device 10 by means of one or more valve 48

In optional step 1150: collecting at least one material from the waste comprised in the waste receptacle 3.

Thereby, dried waste or material from the dehydrated waste may be captured in the waste receptacle 3 and may then be removed from the device 10, e.g. to be disposed of or used as fertilizer as described herein.

In an optional step 1160: capturing particles and/or volatile organic compounds, VOC, from the air downstream of the waste receptacle 3 in the flow direction FD using a capturing device 61.

The capturing device 61 is preferably operatively connected to the air outlet 140. The capturing device 61 may preferably be located in or operatively connected to the air outlet 140 for capturing particles and/or VOC from the air after it has passed through the waste receptacle 3. Thereby, particles and gas that have been released from the human waste may be captured to prevent them from circulating and contaminating the device 10, in embodiments where a circulating airflow is applied, and also to prevent odor from escaping the device 10 so that unpleasant smells are avoided. The capturing device 61 may comprise a filter that is arranged in or operatively connected to the air outlet 140 such that the air passes through the filter. This is a particularly efficient way of achieving the capture of particles and gas.

In an optional step 1180: detecting or determining a moisture content of the waste in the waste receptacle 3.

In an optional step 1190, following step 1180: checking if the detected or determined moisture content is below a predetermined moisture threshold.

If the detected or determined moisture content is not below the predetermined moisture threshold, the method returns to any of the steps 1110, 1120 or 1130 depending on the order of the steps, or to all steps if they are performed in parallel and continuously.

If the detected or determined moisture content is below the predetermined moisture threshold, end the method.

In other words, the handling of waste comprising the steps of cooling air, heating human waste, and conveying air in the device 10 is performed until said moisture content is below the predetermined moisture threshold.

Detecting or determining the moisture content may be done using at least one sensor 11, 21, 44 being operatively connected to the control unit E.

Treating (i.e. drying, dehydrating, or removing moisture from) the human waste in the device 10 according to embodiments herein is preferably performed until it is deemed that the human waste is dry enough. This can be decided by selecting a given time that is considered sufficient for drying the waste, either using a predetermined time or by deciding on a suitable time depending on a property of the human waste itself. That property can be the presence of either urine or feces or both, the moisture content of the waste (urine, feces, or both) or it can alternatively be a weight or volume of the human waste received.

Alternatively, sensors such as the first sensor 11 and second sensor 21 may be used to detect or measure a property such as a moisture content or humidity inside a waste receptacle 3, urine receptacle 1 and/or feces receptacle 2, or alternatively a humidity in the output air AirOUT or in another part of the device 10 that is in fluid communication with the air outlet 140, or alternatively a weight of waste compared to an original weight detected or measured previously. Also, a property pertaining to an amount of energy needed to remove moisture or a quantity of water removed may be detected and/or measured. A combination of these or other properties that indicate a dryness of the human waste may also be used. It is to be noted that urine as well as a mix of urine and feces may be considered dry even when it is still perceived as a liquid as long as a predetermined threshold for moisture content, rate of change of moisture content, weight, or other property of the device 10 is met or fulfilled. Selecting the predetermined threshold or the property may advantageously be based on conditions where the waste (i.e. the urine and/or feces) is deemed sufficiently dry or where it is determined that removal of further moisture is difficult or impossible.

Operation of the device 10 may be continued until a measured or detected property reaches a predetermined threshold, such as a humidity being below a given value or alternatively until a rate of change of the property reaches a given value. This would indicate that the human waste is dry, and operation of the device 10 is interrupted. In an advantageous embodiment, the threshold is a moisture threshold or a rate of change threshold of relative humidity in the airflow.

In an advantageous embodiment, the threshold is instead a weight threshold where the at least one sensor such as the first sensor 11, the second sensor 21 or another sensor provided in connection with the waste receptacle 3 detects or measures a weight of waste in the waste receptacle 3, or in the urine receptacle 1 and/or feces receptacle 2. The predetermined threshold is suitably that the weight of the waste or of the urine or feces has decreased to a given proportion of an original weight detected or measured when the waste first entered the waste receptacle 3 or the urine receptacle 1 and/or feces receptacle 2. Suitably, the predetermined threshold is at least 90% for urine in the urine receptacle 1 and at least 40% for feces in the feces receptacle 2, or alternatively at least 50% for waste in the waste receptacle 3. In some embodiments, the predetermined threshold may be higher such as 95% or even 99% for urine and 50% or even 60% for feces.

In some embodiments, wherein a circulating airflow is used, operation of the device 10 may also be interrupted every time a user uses a receiving unit that is connected to the waste receptacle 3, suitably via the waste pre-treatment receptacle 3′ so that a person opening a lid on the receiving unit or sitting down on the toilet seat of the toilet 3 causes the device 10 to stop. This allows for the at least one first waste conduit 112 to be open in order to convey human waste towards the waste receptacle 3, the urine receptacle 1 and/or the feces receptacle 2 respectively, and also for the at least one waste conduit 112 to be closed when the user is finished so that the circulating airflow in the device 10 does not escape the device 10 through the receiving unit. Preferably, the device 10 in these embodiments forms a closed air loop during operation.

The control unit E may control these processes or alternatively a user may manually activate the device 10 when needed, or it may operate continuously, optionally with interruption only when a user sits on the toilet seat.

Before or during operation of the device 10, i.e. before or during step 1100, 1120 or 1130, the method may further comprise generating a vacuum in a vacuum chamber 210 enclosing the waste receptacle 3 by means of a vacuum pump 220 operatively connected to the vacuum chamber 210.

In some embodiments, the method further comprises cleaning a receiving unit for receiving human waste, said receiving unit being configured to receive waste from a human and transporting said waste to the waste receptacle 3, wherein further cleaning the receiving unit comprises spraying a cleaning fluid into the receiving unit. In some embodiments, the method further comprises using recovered moisture from the device 10 as cleaning fluid, preferably also heating said recovered moisture to generate steam before spraying it into the receiving unit. The recovered moisture may be condensed water or moisture recovered from the air by operation of the moisture recovery device 42 that has been led in a recovered moisture conduit 181 from the device 10 to a recovered moisture receptacle 180 configured to receive and hold such recovered moisture.

Before the steps 1110 of cooling air, 1120 of heating human waste, and 1130 of conveying air in the device, the method may optionally further comprise separating waste in the waste receptacle 3 such that urine is separated into a urine receptacle 1 and feces is separated into a feces receptacle 2.

In all of the method embodiments, the waste that is treated in the device 10 by the method may comprise urine, feces, a urine concentrate, a feces concentrate, a mix of urine and feces or a concentrate from a mix of urine and feces. If the feces are not treated by the airflow of the device 10, it may instead be dried by a separate heating element or may only be stored for subsequent disposal.

Also included in the present invention is another embodiment that differs from the third aspect in the moisture recovery device 42 being arranged downstream of the waste receptacle 3 so that air that enters the device 10 through the air intake 130 passes the waste receptacle 3 before being led to the moisture recovery device 42 and onwards to the air outlet 140. In all other respects, this embodiment is similar or identical to the third aspect described herein.

The method according to any of the embodiments herein may further comprise operating the device 10, or any or all components of the device 10, by means of the control unit E. The control unit E may to this end be configured to perform any, or all, of the method steps described herein for operating the device 10 to treat human waste.

Although embodiments of the invention described above with reference to the figures comprise a control unit E, the invention also extends to computer programs, particularly computer programs on or in a carrier, adapted for putting the invention into practice. The programs may be in the form of source code, object code, a code intermediate source and object code such as in partially compiled form, comprise software or firmware, or in any other form suitable for use in the implementation of the process according to the invention. The program may either be a part of an operating system or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

In one or more embodiments, there may be provided a computer program loadable into a memory communicatively connected or coupled to at least one data processor, e.g. the control unit E, comprising software or hardware for executing the method according any of the embodiments herein when the program is run on the at least one data processor.

In one or more further embodiment, there may be provided a processor-readable medium, having a program recorded thereon, where the program is to make at least one data processor, e.g. the control unit E, execute the method according to of any of the embodiments herein when the program is loaded into the at least one data processor.

It is to be noted that features from the various embodiments described herein may freely be combined, unless it is explicitly stated that such a combination would be unsuitable. It is also to be noted that the different parts of the device may be arranged together to form fewer or more overall components than those described above, so that for instance parts of the drying unit may be arranged in connection with the waste receptacle unit, or vice versa. Also, the cleaning unit, the receiving unit and the control unit may be arranged in connection with each other or with any of the drying unit or waste receptacle unit.

1. Device (10) for treating human waste, the device comprising:
an air intake (130) for passing incoming air (Air_{IN}) into the device (10);
an air outlet (140) for passing outgoing air (Air_{OUT}) out from the device (10);
a moisture recovery device (42) for cooling air, thereby recovering moisture from the air;
a waste receptacle (3) for holding human waste;
a heating device (41) configured to heat human waste comprised in the device (10); and
an air circulation device (45) configured to generate an airflow in the device (10) in a flow direction (FD);
wherein the device (10) is configured to convey air in the flow direction (FD) from the air intake (130) to the moisture recovery device (42), from the moisture recovery device (42) to the waste receptacle (3) and from the waste receptacle to the air outlet (140).

2. The device according to claim 1, wherein the heating device (41) is configured to heat human waste comprised in the device via a medium.

3. The device according to claim 2, wherein the medium is air, and the heating device (41) is arranged downstream of the moisture recovery device (42) and upstream of the waste receptacle (3) in the flow direction (FD), such that the heating device (41) heats the air cooled by the moisture recovery device (42) before the air passes through the waste receptacle (3).

4. The device according to claim 1, wherein the heating device (41) is operatively connected to the waste receptacle (3) for heating human waste or air comprised therein.

5. The device according to any of the claims 1-4 further comprising a connection (43) for transporting air from the air outlet (140) to the air intake (130), such that air is circulated in the device (10).

6. The device according to claim 6, wherein the device (10) forms a closed air loop such that air passes the moisture recovery device (42), the heating device (41) if this is arranged in the airflow, the waste receptacle (3) and the moisture recovery device (42) again during operation of the device (10) without contact with ambient air.

7. The device according to any previous claim, wherein the moisture recovery device (42) is configured to remove moisture from the air through condensation.

8. The device according to any previous claim, wherein the waste receptacle (3) comprises a urine receptacle (1) and a feces receptacle (2), and wherein the waste receptacle (3) further comprises a separator (31) for separating human waste into the urine receptacle and the feces receptacle.

9. The device according to any previous claim, wherein the device (10) further comprises a capturing device (61) for capturing particles and/or volatile organic compounds, VOC, from the air, said capturing device preferably being operatively connected to the air outlet (140).

10. The device according to claim 9, wherein the capturing device (61) comprises a filter that is operatively connected to the air outlet (140) such that the air passes through the filter.

11. The device according to any previous claim, wherein the heating device (41) and the moisture recovery device (42) are part of a heat pump.

12. The device according to any previous claim, wherein the device (10) comprises a valve (48) for selectively introducing ambient air into the device (10).

13. The device according to any previous claim, further comprising a vacuum chamber (210) enclosing the waste receptacle (3), the moisture recovery device (42) and the heating device (41), and a vacuum pump (220) for generating a vacuum in the vacuum chamber (210), the vacuum pump (220) being operatively connected to the vacuum chamber (210).

14. The device according to any previous claim, further comprising a control unit (E) for operating the device (10).

15. The device according to claim 14, further comprising at least one sensor for determining a moisture content of human waste in the waste receptacle (3), wherein the at least one sensor is operatively connected to the control unit (E).

16. Method for treating human waste, the method comprising:
providing a device (10) comprising an air intake (130) for passing incoming air (Air_{IN}) into the device (10), an air outlet (140) for passing outgoing air (Air_{OUT}) out from the device (10), and a waste receptacle (3) for holding human waste;
cooling air in the device (10) by means of a moisture recovery device (42), thereby recovering moisture from the air;
heating human waste comprised in the device (10) by means of a heating device (41); and
conveying air by means of an air circulation device (45) in a flow direction (FD) from the air intake (130) to the moisture recovery device (42), from the moisture recovery device (42) to the waste receptacle (3) and from the waste receptacle (3) to the air outlet (140).

17. The method of claim 16, wherein heating human waste comprised in the device (10) by means of the heating device (41) comprises heating human waste via a medium.

18. The method of claim 17, wherein the medium is air and heating human waste comprised in the device (10) by means of the heating device (41) is done downstream of the cooling of air in the device (10) by means of the moisture recovery device (42) and upstream of the waste receptacle (3) in the flow direction (FD), such that the air cooled by the moisture recovery device (42) is heated before the air passes through the waste receptacle (3).

19. The method of any of the claims 16-18, wherein heating human waste comprised in the device (10) by means of the heating device (41) comprises heating human waste or air in the waste receptacle (3).

20. The method of any of the claims 16-19, further comprising circulating the air in the device (10) by transporting the air via a connection (43) from the air outlet (140) to the air intake (130).

21. The method of claim 20, further comprising conveying air in a closed air loop such that air passes the moisture recovery device (42), the heating device (41) if this is arranged in the airflow, the waste receptacle (3) and the moisture recovery device (42) again during operation of the drying unit without contact with ambient air.

22. The method of any of the claims 16-21, comprising removing moisture from the air through condensation by cooling air in the device (10) by means of the moisture recovery device (42).

23. The method of any of the claims 16-22, further comprising separating waste in the waste receptacle (3) such that urine is separated into a urine receptacle (1) and feces is separated into a feces receptacle (2) before the steps of cooling air, heating human waste, and conveying air in the device (10).

24. The method of any of the claims 16-23, further comprising capturing particles and/or volatile organic compounds, VOC, from the air downstream of the waste receptacle (3) in the flow direction (FD) using a capturing device (61).

25. The method of any of the claims 16-24, further comprising selectively introducing ambient air into the device (10) by means of a valve (48).

26. The method of any of the claims 16-25 further comprising generating a vacuum in a vacuum chamber (210) enclosing the waste receptacle (3) by means of a vacuum pump (220) operatively connected to the vacuum chamber (210).

27. The method of any of the claims 16-27, further comprising operating the device (10) by means of a control unit (E).

28. The method of claim 27, further comprising detecting a moisture content of the waste in the waste receptacle (3), and also comprising performing the steps of cooling air, heating human waste, and conveying air in the device (10) until said moisture content is below a predetermined moisture threshold.

29. Device for treating human waste, the device comprising
a waste receptacle unit (A) for receiving and holding human waste,
a drying unit (B) for drying the human waste, the drying unit (B) comprising
an inlet air conduit (52) connected to the waste receptacle unit such that air is able to enter the waste receptacle unit via the inlet air conduit,
an outlet air conduit (53) connected to the waste receptacle unit such that air is able to exit the waste receptacle unit via the outlet air conduit,
a heating device (41) for heating air, the heating device being operatively connected to the inlet air conduit such that air heated by the heating device is able to enter the inlet air conduit,
a moisture recovery device (42) for recovering moisture from air, the moisture recovery device being operatively connected to the outlet air conduit such that moisture can be recovered from air that has exited the waste receptacle unit through the outlet air conduit,
wherein further the drying unit (B) comprises a connection (43) for transporting air from the moisture recovery device to the heating device, such that air is circulated in the drying unit (B).

30. Device according to claim 29, wherein the drying unit (B) forms a closed air loop such that air passes the heating device, the waste receptacle unit, the moisture recovery device and the heating device again during operation of the drying unit without contact with ambient air.

31. Device according to claim 29 or 30, wherein the waste receptacle unit (A) comprises a urine receptacle (1) and a feces receptacle (2), and wherein the waste receptacle unit (A) further comprises a separator (31) for separating human waste into the urine receptacle and the feces receptacle.

32. Device according to claim 31, further comprising a heating element (22) arranged in connection with the feces receptacle (2) such that the heating element (22) is able to transfer heat to feces held in the feces receptacle (2).

33. Device according to any of claims 31-32, wherein at least one of the urine collection unit (13) and the feces collection unit (23) is replaceable.

34. Device according to any of claims 29-33, wherein the drying unit (B) further comprises a capturing device (61) for capturing particles and/or volatile organic compounds, VOC, from the air, said capturing device preferably being arranged in the outlet air conduit (53), and wherein the capturing device (61) preferably comprises a filter that is arranged in the outlet air conduit (53) such that the air passes through the filter.

35. Device according to any of claims 29-34, further comprising a receiving unit (C) for receiving human waste, and the device also comprising a cleaning device (D) for cleaning the receiving unit (C), the cleaning device (D) comprising at least one nozzle for spraying a cleaning fluid into the receiving unit (C).

36. Device according to claim 35, wherein the cleaning device (C) is operatively connected to the drying unit (B) for receiving recovered moisture from the drying unit (B), and wherein the cleaning fluid is said recovered moisture, and wherein the cleaning device (C) further preferably comprises a steaming unit for heating the cleaning fluid to produce steam and wherein the at least one nozzle is configured for spraying steam into the receiving unit for cleaning.

37. Device according to any previous claim, further comprising a control unit (E) for operating the drying unit (B), and wherein the device further preferably comprises at least one sensor for determining a moisture content of human waste in the waste receptacle unit (A), wherein the at least one sensor is operatively connected to the control unit (E).

38. Method for treating human waste, the method comprising
a) providing a device (10) comprising a drying unit (B) and a waste receptacle unit (A) for receiving and holding human waste,
b) heating air by means of a heating device (41) in the drying unit (B),
c) supplying heated air to the waste receptacle unit (A) for removing moisture from human waste held in the waste receptacle unit (A),
d) transporting air from the waste receptacle unit (A) and recovering moisture from said air by means of a moisture recovery device (42) in the drying unit (B) to create dry air,
and further comprising repeating steps b)-d) by transporting dry air from step d) to be heated again in step b) such that air is circulated in the drying unit (B).

39. Method according to claim 38, wherein the drying unit (B) forms a closed air loop such that air is circulated through steps b)-d) without contact with ambient air.

40. Method according to claim 37 or 38, further comprising
a2) separating waste in the waste receptacle unit (A) such that urine is separated into a urine receptacle (1) and feces is separated into a feces receptacle (2),
wherein step a2) is performed after step a) but before step b).

41. Method according to any of claims 38-40, further comprising filtering air transported from the feces receptacle (2) such that particles from the feces are prevented from being circulated in the drying unit (B).

42. Method according to any of claims 38-41, further comprising heating the feces receptacle by means of a heating element (22).

43. Method according to any of claims 38-42, further comprising replacing at least one of the urine receptacle (1) and feces receptacle (2).

44. Method according to any of claims 38-43, further comprising capturing particles and/or volatile organic compounds, VOC, from the air during step d).

45. Method according to any of claims 38-44, further comprising detecting a moisture content of the waste in the waste receptacle unit (1), and also comprising performing steps b)-d) until said moisture content is below a predetermined moisture threshold.

46. Method according to any of claims 38-45, further comprising cleaning a receiving unit for receiving human waste, said receiving unit (C) being configured to receive waste from a human and transporting said waste to the waste receptacle unit (A), wherein further cleaning the receiving unit comprises spraying a cleaning fluid into the receiving unit (C), and the method preferably further comprising using recovered moisture from the drying unit (B) as cleaning fluid, more preferably also heating said recovered moisture to generate steam before spraying it into the receiving unit.

47. Device for treating human waste, the device comprising
a waste receptacle unit (A) for receiving and holding human waste,
a drying unit (B) for drying the human waste, the drying unit (B) comprising
an inlet air conduit (52) connected to the waste receptacle unit such that air is able to enter the waste receptacle unit via the inlet air conduit,
an outlet air conduit (53) connected to the waste receptacle unit such that air is able to exit the waste receptacle unit via the outlet air conduit,
a heating device (41) for heating human waste in the waste receptacle unit (A),
a moisture recovery device (42) for recovering moisture from air, the moisture recovery device being operatively connected to the outlet air conduit such that moisture can be recovered from air that has exited the waste receptacle unit through the outlet air conduit,
wherein further the drying unit (B) comprises a connection (43) for transporting air from the moisture recovery device to the inlet air conduit (52), such that air is circulated in the drying unit (B).

48. Method for treating human waste, the method comprising
a) providing a device comprising a drying unit and a waste receptacle unit for receiving and holding human waste,
b) heating human waste in the waste receptacle unit by means of a heating device,
c) supplying air to the waste receptacle unit for removing moisture from the heated human waste,
d) transporting air from the waste receptacle unit and recovering moisture from said air by means of a moisture recovery device in the drying unit to create dry air,
and further comprising repeating steps c)-d) by transporting dry air from step d) to the waste receptacle unit again in step c) such that air is circulated in the drying unit.

49. Device (10) for treating human waste, the device comprising:
an air intake (130) for passing incoming air (Air_{IN}) into the device (10);
an air outlet (140) for passing outgoing air (Air_{OUT}) out from the device (10);
a moisture recovery device (42) for cooling air, thereby recovering moisture from the air;
a waste receptacle (3) for holding human waste;
a heating device (41) configured to heat human waste comprised in the device (10); and
an air circulation device (45) configured to generate an airflow in the device (10) in a flow direction (FD);
wherein the device (10) is configured to convey air in the flow direction (FD) from the air intake (130) to the waste receptacle (3), from the waste receptacle (3) to the moisture recovery device (42) and from the moisture recovery device (42) to the air outlet (140).

50. Method for treating human waste, the method comprising:
providing a device (10) comprising an air intake (130) for passing incoming air (Air_{IN}) into the device (10), an air outlet (140) for passing outgoing air (Air_{OUT}) out from the device (10), and a waste receptacle (3) for holding human waste;
cooling air in the device (10) by means of a moisture recovery device (42), thereby recovering moisture from the air;
heating human waste comprised in the device (10) by means of a heating device (41); and
conveying air by means of an air circulation device (45) in a flow direction (FD) from the air intake (130) to the waste receptacle (3), from the waste receptacle (3) to the moisture recovery device (42) and from the moisture recovery device (42) to the air outlet (140).

51. A data processing system comprising means for carrying out the method of any of claim 16-28, 38-46, 48 or 50.

52. A computer program product comprising instructions which, when the program is executed by a computer, cause the computer to carry out the method of any of claim 16-28, 38-46, 48 or 50.

53. A computer-readable storage medium comprising instructions which, when executed by a computer, cause the computer to carry out the method of any of claim 16-28, 38-46, 48 or 50.
